(19) United States
(12) Patent Application Publication
(10) Pub. No.: US 2024/0129819 A1
(43) Pub. Date: Apr. 18, 2024

(54) TRANSMIT-RECEIVE POINT GROUP ACTIVATION AND DEACTIVATION USING LAYER 1 OR LAYER 2 SIGNALING

(71) Applicant: QUALCOMM Incorporated, San Diego, CA (US)

(72) Inventors: Shanyu ZHOU, San Diego, CA (US); Jelena DAMNJANOVIC, Del Mar, CA (US)

(21) Appl. No.: 18/451,561

(22) Filed: Aug. 17, 2023

Related U.S. Application Data
(60) Provisional application No. 63/379,974, filed on Oct. 18, 2022.

(51) Int. Cl. H04W 36/00

(52) U.S. Cl. CPC H04W 36/00835; H04W 36/0085

(57) ABSTRACT

Various aspects of the present disclosure generally relate to wireless communication. In some aspects, a network node may select, for a configured cell set that includes multiple transmit-receive point (TRP) groups, a TRP group modification associated with a cell group of the configured cell set. The network node may transmit the TRP group modification in at least one of layer 1 signaling or layer 2 signaling. Numerous other aspects are described.

### CROSS-REFERENCE TO RELATED APPLICATION

This patent application claims priority to U.S. Provisional Patent Application No. 63/379,974, filed on Oct. 18, 2022, entitled “TRANSMIT-RECEIVE POINT GROUP ACTIVATION AND DEACTIVATION USING LAYER 1 OR LAYER 2 SIGNALING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for transmit-receive point group activation and deactivation using layer 1 or layer 2 signaling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a network node. The method may include selecting, for a configured cell set that includes multiple transmit-receive point (TRP) groups, a TRP group modification associated with a cell group of the configured cell set. In some aspects, the cell group may be an activated cell group of the configured cell set. The method may include transmitting the TRP group modification in at least one of layer 1 (L1) signaling or layer 2 (L2) signaling.

Some aspects described herein relate to a method of wireless communication performed by an apparatus of a user equipment (UE). The method may include receiving, in at least one of L1 signaling or L2 signaling, an indication of a TRP group modification that is associated with a cell group of a configured cell set that includes multiple TRP groups. In some aspects, the cell group may be an activated cell group of the configured cell set. The method may include communicating in a wireless network based at least in part on the TRP group modification.

Some aspects described herein relate to an apparatus for wireless communication at a network node. The apparatus may include one or more memories and one or more processors coupled to the one or more memories memory. The one or more processors may be configured, individually or collectively, to select, for a configured cell set that includes multiple TRP groups, a TRP group modification associated with a cell group of the configured cell set. In some aspects, the cell group may be an activated cell group of the configured cell set. The one or more processors may be configured to transmit the TRP group modification in at least one of L1 signaling or L2 signaling.

Some aspects described herein relate to an apparatus for wireless communication at a UE. The apparatus may include one or more memories and one or more processors coupled to the one or more memories memory. The one or more processors may be configured, individually or collectively, to receive, in at least one of L1 signaling or L2 signaling, an indication of a TRP group modification that is associated with a cell group of a configured cell set that includes multiple TRP groups. In some aspects, the cell group may be an activated cell group of the configured cell set. The one or more processors may be configured to communicate in a wireless network based at least in part on the TRP group modification.

Some aspects described herein relate to a non-transitory computer-readable medium that stores a set of instructions for wireless communication by a network node. The set of instructions, when executed by one or more processors of the network node, may cause the network node to select, for a configured cell set that includes multiple TRP groups, a TRP group modification associated with a cell group of the configured cell set. In some aspects, the cell group may be an activated cell group of the configured cell set. The set of instructions, when executed by one or more processors of the network node, may cause the network node to transmit the TRP group modification in at least one of L1 signaling or L2 signaling.

Some aspects described herein relate to a non-transitory computer-readable medium that stores a set of instructions for wireless communication by a UE. The set of instructions, when executed by one or more processors of the UE, may cause the UE to receive, in at least one of L1 signaling or L2 signaling, an indication of a TRP group modification that is associated with a cell group of a configured cell set that includes multiple TRP groups. In some aspects, the cell group may be an activated cell group of the configured cell set. The set of instructions, when executed by one or more processors of the UE, may cause the UE to communicate in a wireless network based at least in part on the TRP group modification.

Some aspects described herein relate to an apparatus for wireless communication. The apparatus may include means for selecting, for a configured cell set that includes multiple TRP groups, a TRP group modification associated with a cell group of the configured cell set. In some aspects, the cell group may be an activated cell group of the configured cell set. The apparatus may include means for transmitting the TRP group modification in at least one of L1 signaling or L2 signaling.

Some aspects described herein relate to an apparatus for wireless communication. The apparatus may include means for receiving, in at least one of L1 signaling or L2 signaling, an indication of a TRP group modification that is associated with a cell group of a configured cell set that includes multiple TRP groups. In some aspects, the cell group may be an activated cell group of the configured cell set. The apparatus may include means for communicating in a wireless network based at least in part on the TRP group modification.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A and 4B are diagrams illustrating examples of layer 1 and/or layer 2 (L1/L2) inter-cell mobility, in accordance with the present disclosure.

FIGS. 5A, 5B, and 5C are diagrams illustrating a first example, a second example, and a third example of medium access control (MAC) control elements (CEs), in accordance with the present disclosure.

FIG. 6 is a diagram illustrating an example of a wireless communication process between a network node and a UE, in accordance with the present disclosure.

FIG. 7 is a diagram illustrating an example process performed, for example, by a network node, in accordance with the present disclosure.

FIG. 8 is a diagram illustrating an example process performed, for example, by a UE, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

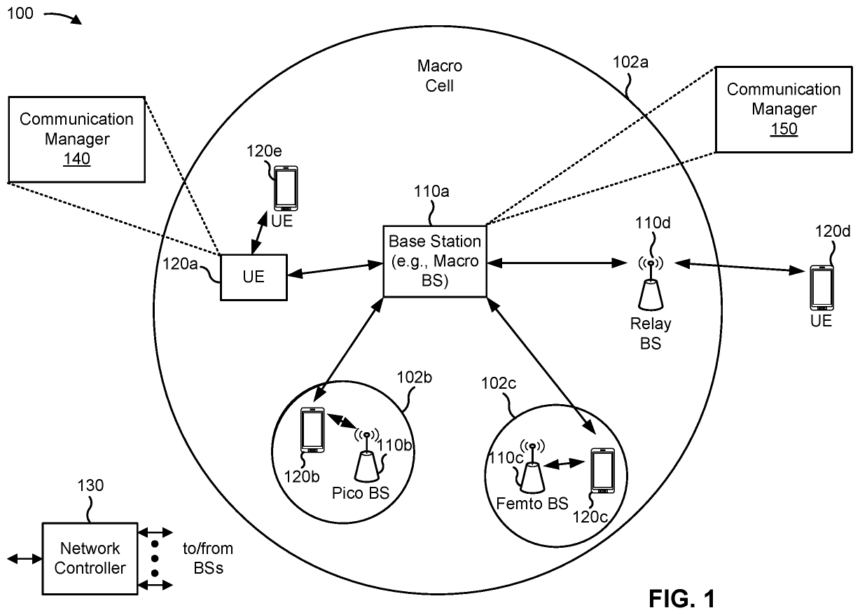

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., one or more memories) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a network node (e.g., the network node 110) may include a communication manager 150. As described in more detail elsewhere herein, the communication manager 150 may select, for a configured cell set that includes multiple TRP groups, a TRP group modification associated with a cell group of the configured cell set; and transmit the TRP group modification in at least one of layer 1 (L1) signaling or layer 2 (L2) signaling. Additionally, or alternatively, the communication manager 150 may perform one or more other operations described herein.

In some aspects, a UE (e.g., the UE 120) may include a communication manager 140. As described in more detail elsewhere herein, the communication manager 140 may receive, in at least one of L1 signaling or L2 signaling, an indication of a TRP group modification that is associated with a cell group of a configured cell set that includes multiple TRP groups; and communicate in a wireless network based at least in part on the TRP group modification. Additionally, or alternatively, the communication manager 140 may perform one or more other operations described herein.

As indicated above, FIG. 1 is provided as an example. Other examples may differ from what is described with regard to FIG. 1.

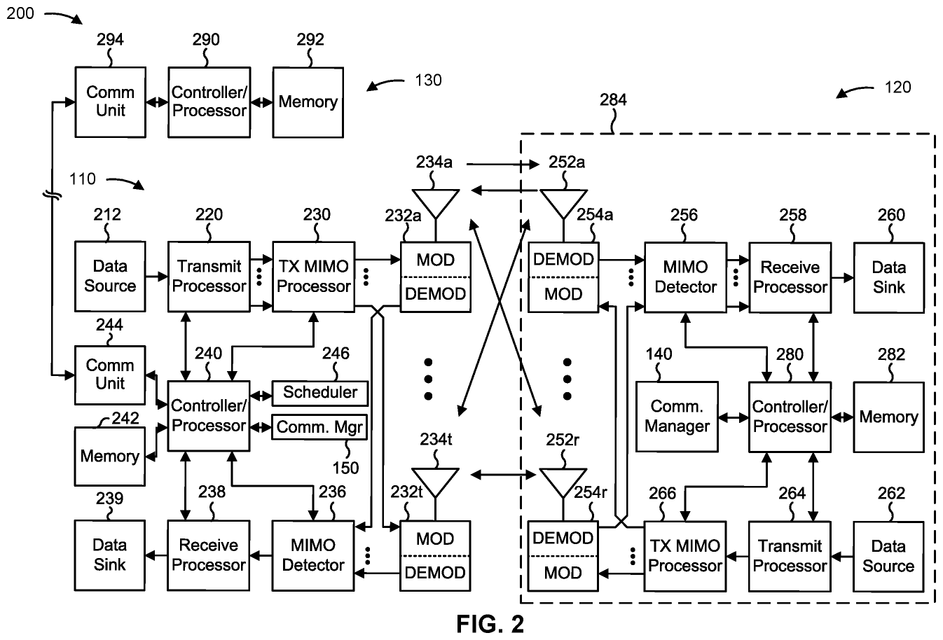

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may select a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

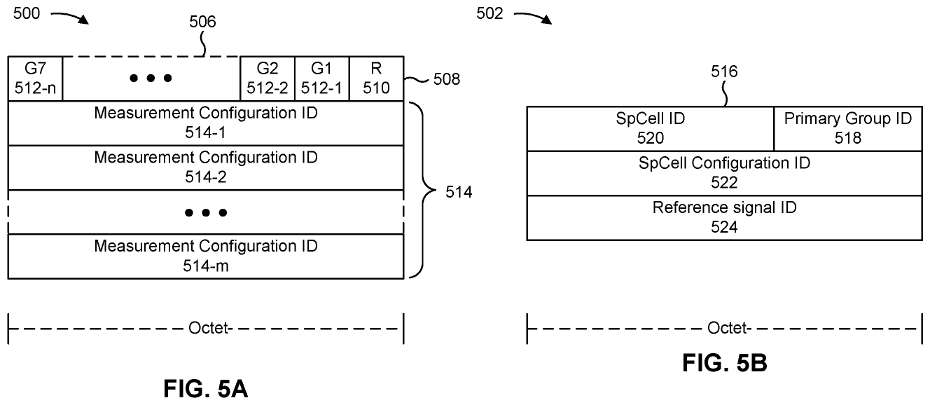

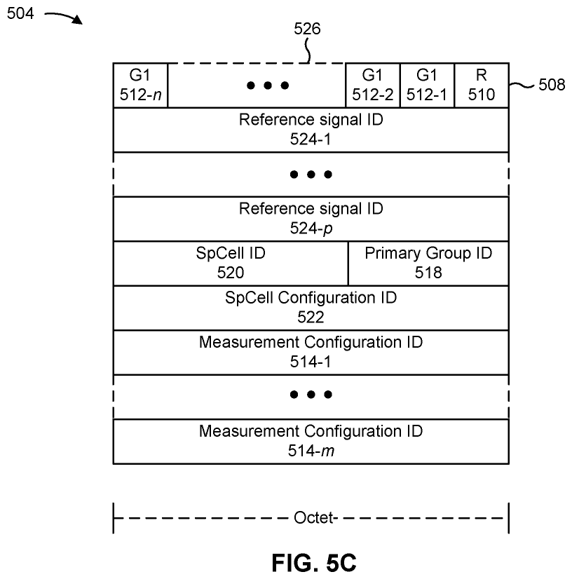

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-10).

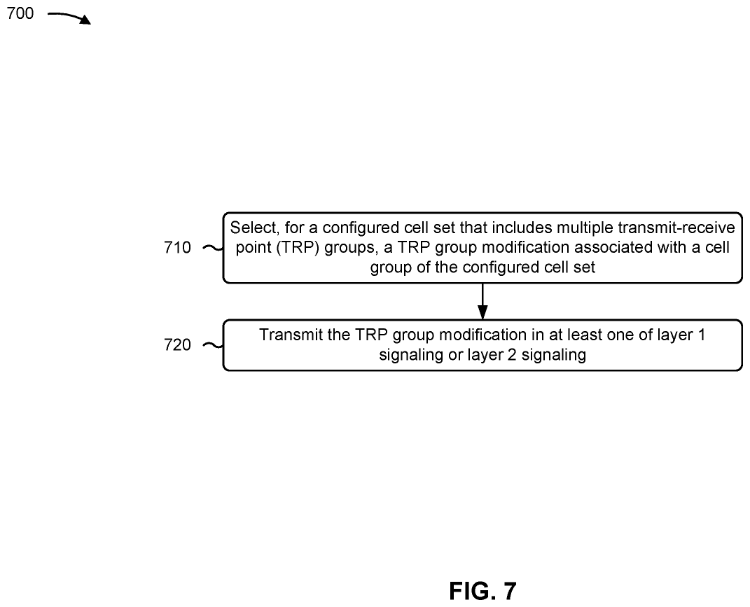

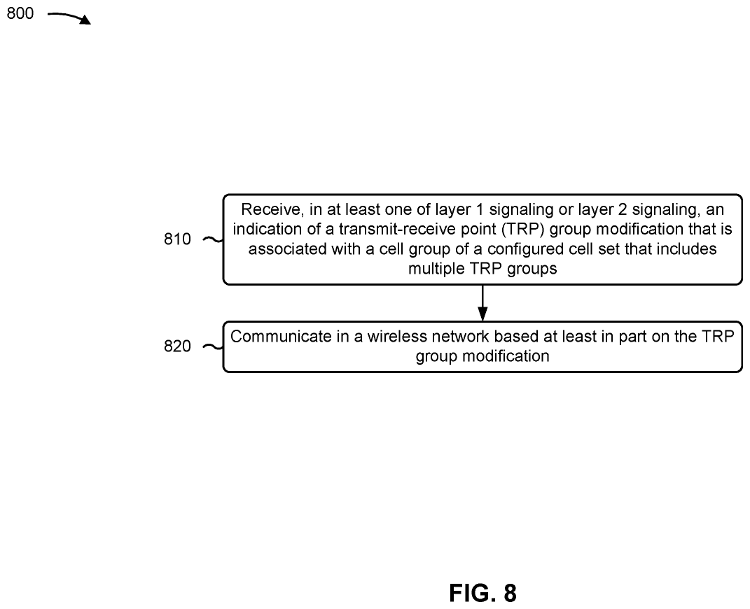

The controller/processor 240 of the network node 110, the controller/processor 280 of the UE 120, and/or any other component(s) of FIG. 2 may perform one or more techniques associated with TRP group activation and deactivation using L1 or L2 signaling, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a network node (e.g., the network node 110) includes means for selecting, for a configured cell set that includes multiple TRP groups, a TRP group modification associated with a cell group of the configured cell set; and/or means for transmitting the TRP group modification in at least one of layer 1 signaling or layer 2 signaling. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a UE (e.g., the UE 120) includes means for receiving, in at least one of layer 1 signaling or layer 2 signaling, an indication of a TRP group modification that is associated with a cell group of a configured cell set that includes multiple TRP groups; and/or means for communicating in a wireless network based at least in part on the TRP group modification. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

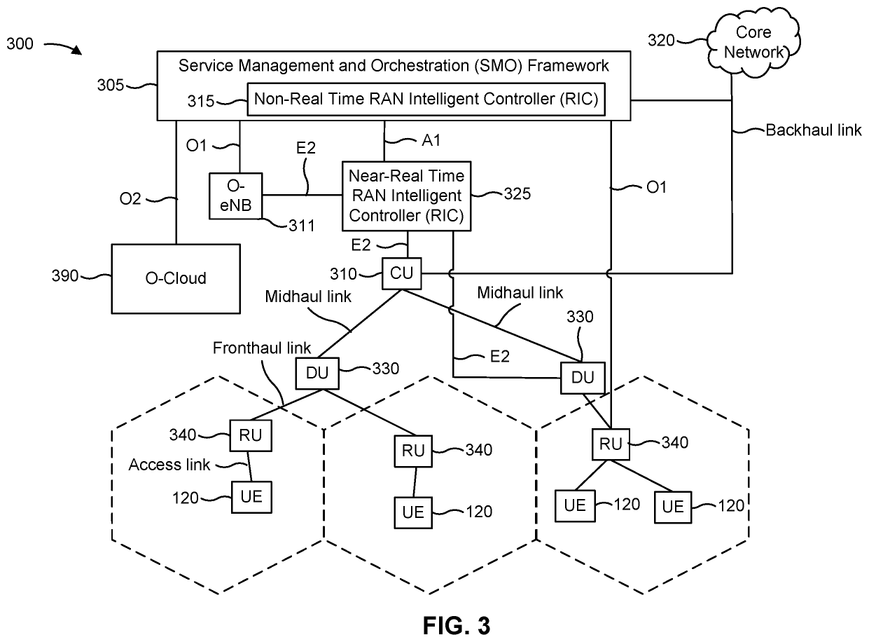

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN), also known as a cloud radio access network (C-RAN). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

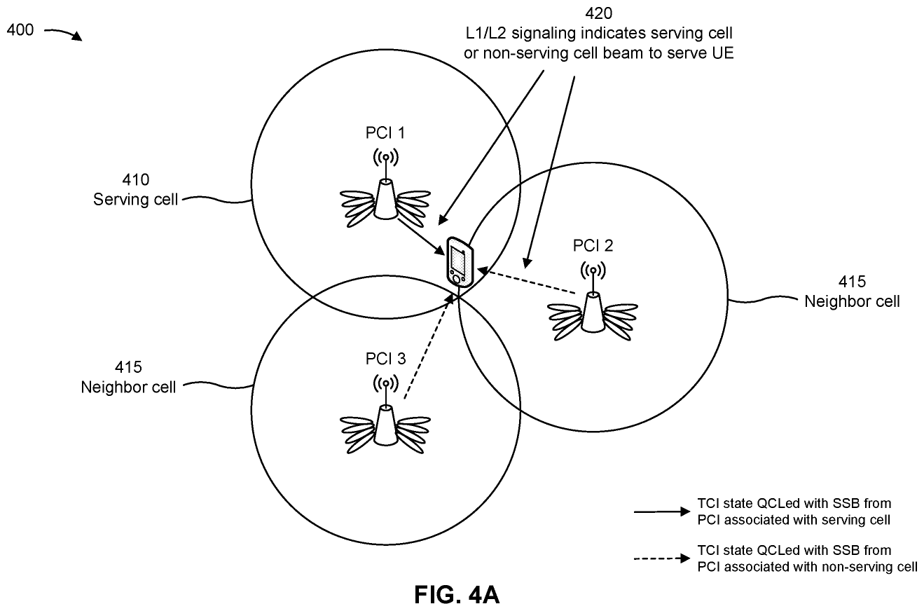

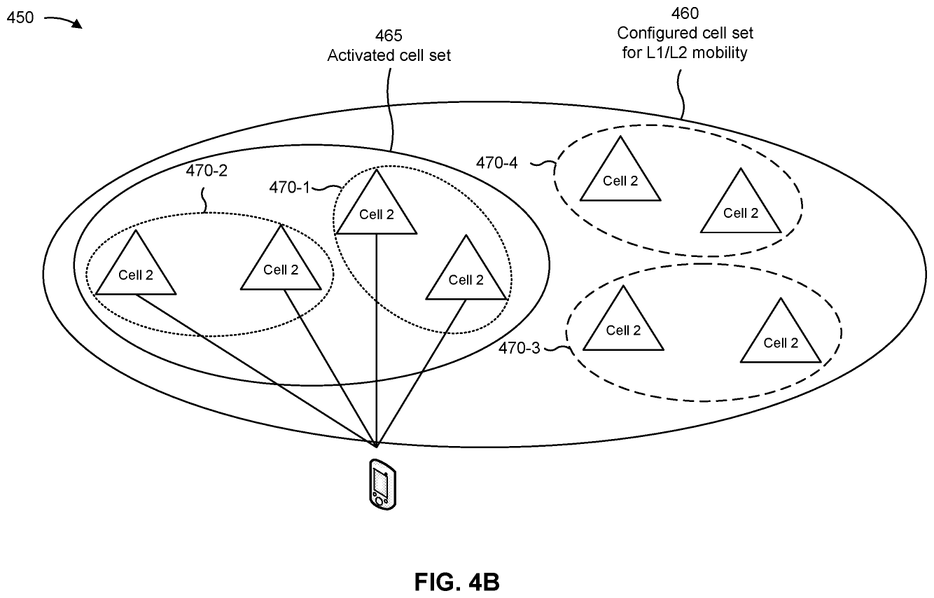

FIGS. 4A-4B are diagrams illustrating examples 400, 450 of Layer 1 and/or Layer 2 (L1/L2) inter-cell mobility, in accordance with the present disclosure.

In a wireless network, such as an NR network, a UE and a network node (e.g., a base station or one or more units or components performing base station functionality) may communicate on an access link using directional links (e.g., using high-dimensional phased arrays) to benefit from a beamforming gain and/or to maintain acceptable communication quality. To achieve acceptable communication quality, the directional links typically use fine alignment of transmit and receive beams, which may be achieved through a set of operations referred to as beam management and/or beam selection, among other examples. Further, a wireless network may support multi-beam operation in a relatively high carrier frequency (e.g., within FR2), which may be associated with harsher propagation conditions than comparatively lower carrier frequencies. For example, relative to a sub-6 gigahertz (GHz) band, signals propagating in a millimeter wave frequency band may suffer from increased pathloss and severe channel intermittency, and/or may be blocked by objects commonly present in an environment surrounding the UE (e.g., a building, a tree, and/or a body of a user, among other examples). Accordingly, beam management is particularly important for multi-beam operation in a relatively high carrier frequency.

One possible enhancement for multi-beam operation in a higher carrier frequency is facilitation of efficient (e.g., low latency and low overhead) downlink and/or uplink beam management to support higher L1/L2-centric inter-cell mobility. Accordingly, one goal for L1/L2-centric inter-cell mobility is to enable a UE to perform a cell switch via dynamic control signaling at lower layers (e.g., downlink control information (DCI) for L1 signaling or a MAC control element (MAC CE) for L2 signaling) rather than semi-static Layer 3 (L3) RRC signaling in order to reduce latency, reduce overhead, and/or otherwise increase efficiency of the cell switch. As one example, the UE may perform an L1/L2 triggered mobility (LTM) procedure.

To illustrate, FIG. 4A shows an example 400 of a first L1/L2 inter-cell mobility technique, which may be referred to as inter-cell mobility scheme 1, beam-based inter-cell mobility, dynamic point selection based inter-cell mobility, and/or non-serving cell-based inter-cell mobility, among other examples. As described in further detail herein, the first L1/L2 inter-cell mobility technique may enable a network node to use L1 signaling (e.g., DCI) or L2 signaling (e.g., a MAC CE) to indicate that a UE is to communicate on an access link using a beam from a serving cell or a non-serving cell. For example, in a wireless network where L1/L2 inter-cell mobility is not supported (e.g., cell switches are triggered only by an L3 handover), beam selection for control information and for data is typically limited to beams within a physical cell identity (PCI) associated with a serving cell. In contrast, in a wireless network that supports the first L1/L2 inter-cell mobility technique (e.g., as shown in FIG. 4A), beam selection for control and data may be expanded to include any beams within a serving cell 410 or one or more non-serving neighbor cells 415 configured for L1/L2 inter-cell mobility.

In the first L1/L2 inter-cell mobility technique shown in FIG. 4A, a UE may be configured with a single serving cell 410, and the UE may be further configured with a neighbor cell set that includes one or more non-serving cells 415 configured for L1/L2 inter-cell mobility. In general, the serving cell 410 and the non-serving cells 415 that are configured for L1/L2 inter-cell mobility may be associated with a common CU and a common DU, or the serving cell 410 and the non-serving cells 415 configured for L1/L2 inter-cell mobility may be associated with a common CU and different DUs. In some aspects, as shown by reference number 420, a base station may trigger L1/L2 inter-cell mobility (e.g., an LTM procedure) for a UE using L1/L2 signaling (e.g., DCI or a MAC CE) that indicates a selected transmission configuration indication (TCI) state quasi co-located (QCLed) with a reference signal (e.g., a synchronization signal block (SSB)) associated with a PCI. For example, in FIG. 4A, the UE may be communicating with the serving cell 410 using a TCI state that is QCLed with an SSB from a PCI associated with the serving cell 410 (e.g., shown as PCI 1 in FIG. 4A), and L1/L2 signaling may trigger inter-cell mobility by indicating that the UE is to switch to communicating using a TCI state that is QCLed with an SSB from a PCI associated with a non-serving neighbor cell 415 (e.g., shown as PCI 2 in FIG. 4A). Accordingly, in the first L1/L2 inter-cell mobility technique, the network node (e.g., the common CU controlling the serving cell 410 and the non-serving neighbor cells 415) may use L1/L2 signaling to select a beam from either the serving cell 410 or a non-serving neighbor cell 415 to serve the UE.

In this way, relative to restricting L1/L2 beam selection to beams within the serving cell 410, the first L1/L2 inter-cell mobility technique may be more robust against blocking and may provide more opportunities for higher rank spatial division multiplexing across different cells. However, the first L1/L2 inter-cell mobility technique does not enable support for changing a primary cell (PCell) or a primary secondary cell (PSCell) for a UE. Rather, in the first L1/L2 inter-cell mobility technique, triggering a Pcell or PSCell change is performed via a legacy L3 handover using RRC signaling. In this respect, the first L1/L2 inter-cell mobility technique is associated with a limitation that L1/L2 signaling can only be used to indicate a beam from the serving cell 410 or a configured neighbor cell 415 while the UE is in the coverage area of the serving cell 410 because L1/L2 signaling cannot be used to change the Pcell or PSCell. A special cell (SpCell) may be used to refer to either a Pcell or an PSCell.

FIG. 4B illustrates an example 450 of a second L1/L2 inter-cell mobility technique, which may be referred to as inter-cell mobility scheme 2 and/or serving cell-based inter-cell mobility, among other examples. As shown in FIG. 4B, the second L1/L2 inter-cell mobility technique may use mechanisms that are generally similar to carrier aggregation to enable L1/L2 inter-cell mobility, except that different cells configured for L1/L2 inter-cell mobility may be on the same carrier frequency. As shown in FIG. 4B, a network node may configure and/or manage a configured cell set 460 for L1/L2 inter-cell mobility (e.g., using RRC signaling). The configured cell set 460 may include one or more cells that may be any combination of network nodes, such as one or more RUs and/or one or more TRPs. A configured cell set may alternatively or additionally include and/or be referred to as LTM candidate cells and/or an LTM candidate cell set.

In some aspects, a managing network node (e.g., a CU, a DU, and/or a base station) may manage the configured cell set 460. To illustrate, the managing network node may group one or more cells together such that the configured cell set 460 includes multiple groupings (e.g., a cell group). That is, the managing network node may configure the cells in a cell group to communicate together and/or configure a UE to communicate with the cells as a group. For example, an activated cell set 465 may include one or more cells in the configured cell set 460 that are grouped together in a cell group that is activated by the managing network node and ready to use for data and/or control transfer. In some aspects, an activated cell set (e.g., the activated cell set 465) may be alternatively or additionally referred to as a serving cell group and/or a serving cell set that provides wireless service to a UE (e.g., a UE 120). In some aspects, a TRP group may be a cell group in which each TRP within the group uses a same carrier frequency for operation and/or are configured within one cell.

As shown by example 450, the activated cell set 465 may include a first cell group 470-1 and a second cell group 470-2. In some aspects, each activated cell group may be configured (e.g., by the managing network node) with at least one PCell, PSCell, and/or SpCell. In some aspects, one or more secondary cells within a cell group may be configured with an SpCell and/or PCell configuration. Alternatively or additionally, in the second L1/L2 inter-cell mobility technique, the configured cell set 465 may include one or more deactivated cell groups. “Deactivated cell group” and/or “deactivated cell set” may denote a group of one or more cells and/or TRPs (e.g., within the configured cell set 460) that are configured for L1/L2 inter-cell mobility (e.g., an LTM candidate cell set and/or LTM candidate cells), but are not included in the activated cell set 465. That is, a deactivated cell group may include non-serving cells. To illustrate, the configured cell set 460 shown by the example 450 includes a third cell group 470-3 and a fourth cell group 470-4 that are deactivated cell groups (e.g., non-serving cell groups) and are not included in the activated cell set 465.

For cells configured within a cell group (e.g., the first cell group 470-1, the second cell group 470-2, the third cell group 470-3, and/or the fourth cell group 470-4), activation and/or deactivation may be performed on a group level. To illustrate, if a component carrier (CC) of a cell group is deactivated, all cells (e.g., a TRP and/or an RU) within the cell group are deactivated. Similarly, a primary cell (e.g., a primary TRP and/or a primary RU) within a cell group may not be switched with an additional cell within the cell group using L1/L2 signaling. That is, a first cell acting as a PCell and/or an SpCell within an activated cell group may not be explicitly switched out with a second cell within the activated cell group using L1/L2 signaling.

The inability to reconfigure the activated cell group, such as by switching a PCell and/or an SpCell, using L1/L2 signaling may introduce delays in the reconfiguration process. That is, using legacy L3 signaling to reconfigure the activated cell group may introduce delays. To illustrate, transmitting a reconfiguration associated with the activated cell group based at least in part on L3 signaling may cause a delay that results in the activated cell group and/or a UE applying an outdated reconfiguration as the UE moves. For instance, the reconfiguration may be based at least in part on the UE operating at a first location, and a delay in applying the reconfiguration may result in the UE moving to a second location that makes the reconfiguration outdated upon completing the related modifications. The outdated reconfiguration may reduce signal quality in UE communications, increase recovery errors, and/or increase data transfer delays.

Some techniques and apparatuses described herein provide TRP group activation and deactivation using L1 signaling or L2 signaling. A network node may select, for a configured cell set that includes multiple TRP groups, a TRP group modification associated with a cell group of the configured cell set. As one example, the network node may select, as the TRP group modification, to add a first TRP group to an activated cell group by activating the first TRP group and/or to remove a second TRP group from the activated cell group by deactivating the second TRP group. Alternatively or additionally, the network node may select, as the TRP group modification, to change one or more SpCells of one or more TRP groups within the activated cell group. The network node may transmit the TRP group modification and/or an indication of the TRP group modification in at least one of L1 signaling or L2 signaling.

In some aspects, a UE may receive, in at least one of L1 signaling or L2 signaling, an indication of a TRP group modification that is associated with a cell group (e.g., one or more serving cells) of a configured cell set that includes multiple TRP groups, such as a configured cell set that includes an LTM candidate cell set and/or LTM candidate cells. In some aspects, the cell group may be an activated cell group of the configured cell set. As one example, the UE may receive the indication of the TRP group modification based at least in part on a transmission from the activated cell group. The UE may communicate in a wireless network based at least in part on the TRP group modification.

The ability to signal an indication of a TRP group modification (e.g., a TRP group activation, a TRP group deactivation, an SpCell change, and/or an SpCell configuration change) in L1 signaling and/or L2 signaling reduces a delay associated with a UE applying the TRP group modification relative to L3 signaling that indicates the TRP group modification. Reducing the delay improves a responsiveness of the UE in applying the TRP group modification, and reduces a probability that the TRP group modification is outdated. That is, the UE may apply a current and relevant TRP group modification, instead of an outdated TRP group modification, that improves a signal quality associated with UE communications, reduces recovery errors, and/or reduces data transfer delays.

As indicated above, FIGS. 4A-4B are provided as examples. Other examples may differ from what is described with regard to FIGS. 4A-4B.

FIGS. 5A, 5B, and 5C are diagrams illustrating a first example 500, a second example 502, and a third example 504 of MAC CEs, in accordance with the present disclosure. While the first example 500, the second example 502, and the third example 504 describe one or more fields included in a MAC CE, aspects of these examples may be included in DCI. For example, one or more fields described with regard to the first example 500, the second example 502, and the third example 504 may be included in DCI. Accordingly, aspects of the first example 500, the second example 502, and/or the third example 504 may be indicated using L1 signaling (e.g., DCI) and/or L2 signaling (e.g., a MAC CE).

The first example 500 shows an example structure of a TRP group activation MAC CE 506 that a network node may signal based at least in part on selecting a modification and/or a change to a configuration of a TRP group that is associated with a configured cell set as described herein. A size of each field included in the TRP group activation MAC CE 506 is shown in FIG. 5A in relation to an octet of bits, but in other examples, each field may span more or fewer bits. In some aspects, the TRP group activation MAC CE 506 may be associated with a particular logical channel identifier (LCID) that is specific to an activation state of a cell group and/or TRP group.

The TRP group activation MAC CE 506 may include an activation state field 508 that may span a first octet of bits. In some aspects, the activation state field 508 may be based at least in part on a bit field and/or a bitmap, and each bit of the bit field may indicate information that is independent from information indicated by the other bits included in the bit field. As one example, a first bit of the activation state field 508 may be designated as a reserved bit 510 (shown as R 510), and one or more remaining bits of the activation state field 508 may indicate an activation state (e.g., an enabled activation state or a disabled activation state) for a particular TRP group within a configured cell set. To illustrate, a first TRP group activation state bit 512-1 may indicate a first activation state associated with a first TRP group within the configured cell set, a second TRP group activation state bit 512-2 may indicate a second activation state associated with a second TRP group within the configured cell set, and an n-th TRP group activation state bit 512-n may indicate an n-th activation state associated with an n-th TRP group within the configured cell set, where n is an integer (e.g., n=7 in the first example 500). For instance, a first bit value (e.g., “0”) may indicate a disabled activation state for the associated TRP group, and a second bit value (e.g., “1”) may indicate an enabled activation state for the associated TRP group. In some aspects, a network node (e.g., the network node 110) may indicate, prior to transmitting the TRP group activation MAC CE 506, a mapping of each TRP group activation state bit to a particular TRP group. For example, the network node may transmit an RRC message to a UE (e.g., the UE 120) that indicates a mapping of a particular activation state bit within the bit field to a particular TRP group and/or TRP group identifier (ID). In some aspects, the network node may indicate a TRP group ID of an activated TRP group (e.g., a serving TRP group) in the activation state field 508. That is, the network node may indicate a value of the TRP group ID.

The TRP group activation MAC CE 506 may include one or more of a measurement configuration ID field 514 (shown as measurement configuration ID 514). A measurement configuration field may indicate an L1 measurement configuration and/or an L1 measurement reporting configuration for an L1 measurement that is associated with a disabled TRP group, such as, by way of example and not of limitation, a target frequency and/or a target reference signal. For instance, a particular measurement configuration field may be associated with a particular TRP group that the activation state field 508 indicates has a disabled activation state. To illustrate, and as shown in FIG. 5A, the TRP group activation MAC CE 506 may include a first measurement configuration ID field 514-1, a second measurement configuration ID field 514-2, up to an m-th measurement configuration ID field 514-m, where m is an integer. Each measurement configuration field may be associated with a respective deactivated TRP group (e.g., a non-serving TRP group) and indicate an L1 measurement configuration to use for performing an L1 measurement based at least in part on one or more signals from the deactivated TRP group, such as an SSB associated with the deactivated TRP group. As one example, before transmitting the TRP group activation MAC CE 506, a network node (e.g., the network node 110) may indicate multiple measurement configurations and/or multiple measurement reporting configurations to a UE (e.g., the UE 120) in an RRC message. In some aspects the network node may assign a respective measurement configuration ID to each measurement configuration and/or measurement reporting configuration in the RRC message, and indicate a particular measurement configuration ID in a measurement configuration field.

In some aspects, the TRP group activation MAC CE 506 may optionally include or exclude one or more of the measurement configuration ID field 514. For instance, the activation state field 508 may indicate all TRP groups are in an enabled activation state. Accordingly, the TRP group activation MAC CE may exclude the measurement configuration fields. In some aspects, the reserved bit 510 may be set to a measurement inclusion state value that specifies that the TRP group activation MAC CE 506 lacks the measurement configuration fields. For instance, a first measurement inclusion state value (e.g., “0”) may indicate the TRP group activation MAC CE 506 does not include any measurement configuration fields and a second measurement inclusion state value (e.g., “1”) may indicate that the TRP group activation MAC CE 506 includes at least one measurement configuration field. A UE receiving the TRP group activation MAC CE 506 may alternatively or additionally derive a number of measurement configuration fields included in the TRP group activation MAC CE 506 based at least in part on a number of bits in the activation state field 508 that indicate a disabled activation state. The TRP group activation MAC CE 506 may indicate each measurement configuration field in an order that is based at least in part on one or more TRP group identifiers (e.g., in a numerically increasing order or a numerically decreasing order) and/or a bit order associated with the activation state field 508. For instance, a first TRP group that is associated with the lowest least significant bit in the activation state field 508 that indicates a deactivated activation state may be associated with a first listed measurement configuration field. A second TRP group that is associated with the next lowest least significant bit in the activation state field 508 that indicates a deactivated activation state may be associated with a second listed measurement configuration field. Other examples may include an order that is based at least in part on a most significant bit.

The second example 502 of FIG. 5B shows an example structure of a primary TRP group configuration MAC CE 516 that a network node (e.g., the network node 110) may signal based at least in part on selecting a modification and/or a change to a primary TRP group that is associated with a configured cell set as described herein. To illustrate, the network node may signal the primary TRP group configuration MAC CE 516 based at least in part on selecting to change a primary TRP group of an activated cell group from a first TRP group to a second TRP group. In some aspects, the structure associated with the primary TRP group configuration MAC CE 516 may be based at least in part on an octet of bits as shown by the example 502. However, in other examples, the structure of a primary TRP group configuration MAC CE may be based at least in part on more or fewer bits than an octet. In some aspects, the network node may signal the TRP group activation MAC CE 506 of FIG. 5A and the primary TRP group configuration MAC CE 516 of FIG. 5B using separate messages.

The primary TRP group configuration MAC CE 516 may include a primary TRP group ID field 518 (shown as primary group ID 518) that indicates to activate a particular TRP group as the primary TRP group. While the second example 502 shows the primary TRP group ID field 518 as spanning a portion of a first octet of the primary TRP group configuration MAC CE 516, the primary TRP group ID field 518 may span an entirety of an octet or span more than one octet. In some aspects, a network node may indicate, in the primary TRP group ID field 518, a value that specifies a particular TRP group to use as a primary TRP group. For instance, the network node may indicate a value and/or enumerator associated with a particular TRP group ID. As another example, the primary TRP group ID field 518 may be configured as a bit field and/or bitmap that maps each bit of the field to a respective TRP group (e.g., by way of an RRC message). The network node may indicate, for a particular bit within the field that is associated with a particular TRP group, a first value (e.g., “1”) that specifies to use the particular TRP group as the primary TRP group. Alternatively or additionally, the network node may indicate, for other bits within the field, a second value (e.g., “0”) that specifies not to use the other TRP groups as the primary TRP group. In some aspects, selection of a particular TRP group as the primary TRP group may indicate an enabled activation state for the particular TRP group.

In some aspects, the primary TRP group ID field 518 may include an explicit instruction to deactivate a particular TRP group as the primary TRP group. For instance, the network node may set a bit value associated with the particular TRP group to a value (e.g., the second value) that specifies to not use and/or deactivate the particular TRP group as the primary TRP group. In other aspects, the primary TRP group ID field 518 may include an implicit instruction to deactivate the particular TRP group as the primary TRP group. For instance, the network node may indicate a TRP group ID of another TRP group in the primary TRP group ID field 518 and implicitly indicate to deactivate the particular TRP group as the primary group based at least in part on not indicating the particular TRP group ID.

The primary TRP group configuration MAC CE 516 may include an SpCell ID field 520 (shown as SpCell ID 520) that spans a second portion of the first octet. However, the SpCell ID field 520 may span an entirety of an octet or span more than one octet. In some aspects, a network node may indicate, in the SpCell ID field 520, a pointer to a TRP group ID associated with a particular TRP group to activate as an SpCell of the primary TRP group. Alternatively or additionally, the network node may indicate, in the SpCell ID field 520, an index of the TRP group to activate as the SpCell. For instance, the configured cell may include multiple TRP groups that are each assigned a respective index within the configured cell, and the network node may indicate a particular index in the SpCell ID field 520.

The primary TRP group configuration MAC CE 516 may include an SpCell configuration ID field 522 (shown as SpCell configuration ID 522), which may alternatively be referred to as an LTM candidate configuration ID field. Although the example 502 shows the SpCell configuration ID field 522 spanning a second octet of the primary TRP group configuration MAC CE 516, other examples may span more or fewer bits. In some aspects, a network node (e.g., the network node 110) may indicate (e.g., using RRC signaling and prior to transmitting the primary TRP group configuration MAC CE 516) multiple SpCell configurations and/or SpCell configuration IDs to a UE (e.g., the UE 120). An SpCell configuration may indicate a variety of information associated with an SpCell (e.g., an SpCell specified by the SpCell ID field 520), such as an initial bandwidth part (BWP), an activated downlink BWP, an activated uplink BWP, a deactivation time value, and/or a cross carrier schedule. Alternatively or additionally, the UE may indicate one or more supported SpCell configurations to the network node, such as in capability information and/or in an RRC response to the multiple SpCell configurations that are indicated by network node. For instance, the UE may indicate, as the one or more supported SpCell configurations, a subset of the multiple SpCell configurations indicated by the network node. Each SpCell configuration may be assigned an SpCell configuration ID and/or index (e.g., either by the network node in an RRC message or by the UE). In some aspects, the network node may indicate, in the SpCell configuration ID field 522, a particular SpCell configuration ID selected from the SpCell configurations supported by the UE and/or from the multiple SpCell configurations indicated by the network node.

The SpCell configuration ID field 522 may be configured as a bitmap in which each bit of the SpCell configuration ID field 522 is mapped to a particular SpCell configuration (e.g., a mapping indicated based at least in part on an RRC message). To indicate a particular SpCell configuration, the network node may set a bit of the SpCell configuration ID field 522 (e.g., a bit that maps to the particular SpCell configuration) to a first value (e.g., “1”) that specifies to communicate with the SpCell based at least in part on the particular SpCell configuration. Alternatively or additionally, the network node may indicate, for other bits within the field, a second value (e.g., “0”) that specifies to not use the other SpCell configurations to communicate with the SpCell.

The primary TRP group configuration MAC CE 516 may include a reference signal ID field 524 (shown as reference signal ID 524). Although shown in the example 502 as spanning a third octet of the primary TRP group configuration MAC CE 516, other examples of the reference signal ID field 524 may span more or fewer bits. In some aspects, the reference signal ID field 524 may indicate a reference signal ID that maps to reference signal configuration information. To illustrate, the reference signal configuration information may indicate one or more configuration parameters associated with a channel state information reference signal (CSI-RS) for tracking (TRS). A network node (e.g., the network node 110) may signal, in the reference signal ID field 524, a pointer to a particular reference signal configuration (e.g., a CSI-RS configuration and/or a TRS configuration). In some aspects, the reference signal configuration may indicate a TCI state associated with an SpCell TRP group, such as a TCI state associated with performing beam management for the SpCell TRP group.

A network node may conditionally signal the reference signal ID field 524 as part of the primary TRP group configuration MAC CE 516. To illustrate, the network node may (conditionally) refrain from indicating the reference signal ID field 524 based at least in part on an associated SpCell TRP group having an enabled activation state. That is, the associated SpCell TRP group (e.g., indicated by the SpCell ID field 520) may already have an association with a reference signal, a reference signal ID, and/or reference signal configuration information based at least in part on currently being in an enabled activated state at a transmission time of the primary TRP group configuration MAC CE 516. As another example, the network node may (conditionally) indicate the reference signal ID field 524 based at least in part on the associated SpCell TRP group having a disabled activation state. That is, the primary TRP group configuration MAC CE 516 may indicate to transition the associated SpCell TRP group from a disabled activation state to an enabled activation state, and the network node network node may (conditionally) include the reference signal ID field 524 in the primary TRP group configuration MAC CE 516.

The third example 504 of FIG. 5C shows an example structure of a joint TRP group activation and primary TRP group configuration MAC CE 526 (joint MAC CE 526) that a network node (e.g., the network node 110) may signal based at least in part on selecting a modification and/or a change to a TRP group configuration and/or a primary TRP group that is associated with a configured cell set as further described. As shown by the third example 504, the joint MAC CE 526 may include aspects of the TRP group activation MAC CE 506 as described with regard to FIG. 5A and/or the primary TRP group configuration MAC CE 516 as described with regard to FIG. 5B. A network node may signal the joint MAC CE 526 using a single message. In some aspects, the joint MAC CE 526 may be associated with a particular logical channel identifier (LCID) that is specific to an activation state of a cell group and/or TRP group.

As shown by the third example 504, the joint MAC CE 526 may include the activation state field 508 as described with regard to FIG. 5A. The activation state field 508 may be based at least in part on a bit field and/or a bitmap that maps a bit to a respective TRP group as further described. The activation state field 508 of the joint MAC CE 526 may include the reserved bit 510 and multiple activation state bits (shown as the first activation state bit 512-1, the second activation state bit 512-2, up to the n-th activation state bit 512-n). A number of bits associated with the activation state field 508 (e.g., whether included in the joint MAC CE 526 or the TRP group activation MAC CE 506) may be based at least in part on a number of TRP groups that may be activated at a same time. For instance, the number of activated TRP groups may be based at least in part on a first maximum number of (allowable) activated TRP groups that is specified by a communication standard, a second maximum number of available TRP groups within an activated cell set (e.g., a serving cell set), and/or a third maximum number of activated TRP groups supported by a UE. Accordingly, a number of bits included in the activation state field 508 of the joint MAC CE 526 may be based at least in part on the maximum number of allowable, available, and/or supported activated TRP groups. Alternatively or additionally, the number of bits included in the activation state field 508 of the joint MAC CE 526 may be based at least in part on the inclusion of a reserved bit.

The joint MAC CE 526 may include one or more reference signal ID fields 524 (as described with regard to FIG. 5B), shown in FIG. 5C as a first reference signal ID field 524-1 up to a p-th reference signal ID field 524-p, where p is an integer. In some aspects, the network node may indicate, as part of the joint MAC CE 526, a respective reference signal ID field (e.g., that indicates a reference signal configuration) for each deactivated TRP group indicated in the activation state field 508. Alternatively or additionally, the network node may indicate a respective reference signal ID field for each activated TRP group of the multiple TRP groups. The network node may indicate a reference signal configuration (e.g., a CSI-RS configuration and/or a TRS configuration) in each reference signal ID field. While the example 526 shows each reference signal identifier field as being an eight-bit field (e.g., an octet), other examples may use more or fewer bits.

As shown by the example 504, the joint MAC CE 526 may include the primary TRP group identifier field 518, the SpCell ID field 520, and the SpCell configuration ID field 522, as described with regard to FIG. 5B. A field position of a field and/or a size of the primary TRP group ID field 518, the SpCell ID field 520, and the SpCell configuration ID field 522 may vary from what is shown by the example 504. As one example, the primary TRP group identifier field 518, the SpCell ID field 520, and the SpCell configuration ID field 522 may be based at least in part on using a single octet of bits within the joint MAC CE 526 (or other MAC CEs). As another example, the primary TRP group ID field 518, the SpCell ID field 520, and the SpCell configuration ID field 522 may be based at least in part on using multiple octet of bits within the joint MAC CE 526, such as a first octet of bits for the primary TRP group ID field 518, a second octet of bits for the SpCell ID field 520, and a third octet of bits for the SpCell configuration ID field 522. A reserved bit, such as the reserved bit 510, may also be positioned in one or more different locations within the joint MAC CE 526 than shown by the first example 500, the second example 502, and/or the third example 504, such as within the first octet of bits, the second octet of bits, and/or the third octet of bits.

The joint MAC CE 526 may include one or more of the measurement configuration ID field 514 as described with regard to FIG. 5A, shown by the third example 504 as a first measurement configuration ID field 514-1 up to an m-th measurement configuration ID field 514-m where m is an integer. As one example, a network node (e.g., the network node 110) may indicate multiple measurement configuration fields based at least in part on indicating multiple deactivated TRP groups in the joint MAC CE 526 (e.g., multiple bits that indicate a disabled activation state for an associated TRP group). To illustrate, the network node may indicate, by way of signaling the joint MAC CE 526, a respective measurement configuration field for each deactivated TRP group.

In some aspects, the network node may signal, as part of the joint MAC CE 526, the multiple measurement configuration ID fields based at least in part on using an order associated with a TRP group ID. For instance, the network node may signal the multiple measurement configuration ID fields based at least in part on an ascending and/or increasing numerical order of the associated TRP group IDs. That is, a first measurement configuration field associated with a first deactivated TRP group that has a lowest TRP group ID value may be signaled first, and a second measurement configuration field associated with a second deactivated TRP group that has a highest TRP group ID value may be signaled last (or vice versa). In some aspects, one or more of the measurement configuration ID fields may indicate and/or specify an association between at least two TRPs that are included in the respective deactivated TRP group. For instance, a measurement configuration ID field may point to a measurement configuration and/or measurement reporting configuration that specifies the association.

A size of the joint MAC CE 526 and/or a number of fields included in the joint MAC CE 526 may be based at least in part on a TRP group modification. To illustrate, the TRP group modification selected by a network node may include one or more TRP group activation and/or deactivation modifications, but exclude primary TRP group modifications. Accordingly, the network node may conditionally exclude one or more fields within the joint MAC CE 526 that are associated with a primary TRP group modification (e.g., the primary TRP group identifier field 518, the SpCell ID field 520, and/or the SpCell configuration ID field 522). Alternatively or additionally, the network node may indicate that the joint MAC CE 526 excludes the one or more fields associated with primary TRP group modification, such as by setting a reserved bit to a first value or a second value. In other examples, the network node may conditionally include the one or more fields within the joint MAC CE 526 based at least in part on selecting, as the TRP group modification, a primary TRP group modification.

The first example 500, the second example 502, and the third example 504 describe one or more fields that may be included in a MAC CE or DCI to enable a network node to indicate TRP group activation and/or deactivation information and/or primary group configuration information to a UE using L1 signaling and/or L2 signaling. The ability to signal an indication of a TRP group modification (e.g., a TRP group activation, a TRP group deactivation, an SpCell change, and/or an SpCell configuration change) in L1 signaling and/or L2 signaling reduces a delay in a UE applying the TRP group modification relative to L3 signaling that indicates the TRP group modification. Reducing the delay improves a responsiveness of the UE in applying the TRP group modification, and reduces a probability that the TRP group modification applied by the UE is outdated. That is, the UE applying a current (and relevant) TRP group modification instead of an outdated TRP group modification may improve a signal quality associated with UE communications, reduce recovery errors, and/or reduce data transfer delays.

As indicated above, FIGS. 5A, 5B, and 5C are provided as examples. Other examples may differ from what is described with regard to FIGS. 5A, 5B, and 5C.

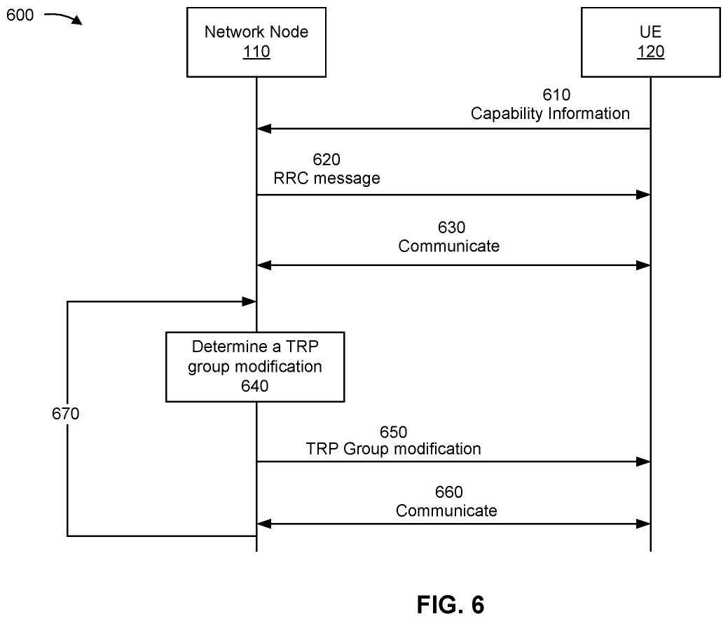

FIG. 6 is a diagram illustrating an example 600 of a wireless communication process between a network node (e.g., the network node 110) and a UE (e.g., the UE 120), in accordance with the present disclosure. For visual clarity, the example 600 shows the network node 110 as a singular network node, but may include multiple network nodes that are based at least in part on a disaggregated architecture, such as that described with regard to FIG. 3, and/or cell groups as further described with regard to FIG. 4B.

As shown by reference number 610, a UE 120 may transmit, and a network node 110 may receive, capability information. As one example, the UE 120 may transmit, as part of the capability information, an indication of a number of activated cell groups (e.g., a number of serving cells) within a configured cell set that are supported by the UE.

As shown by reference number 620, the network node 110 may transmit, and the UE 120 may receive, one or more RRC messages. In some aspects, the network node may transmit an RRC message that indicates multiple TRP groups within a configured cell set and/or a respective TRP group ID for each TRP group. Alternatively or additionally, the network node may transmit, in an RRC message, one or more measurement configurations, one or more measurement reporting configurations, one or more reference signal configurations, and/or one or more SpCell configurations. In transmitting any combination of the measurement configuration(s), the measurement reporting configuration(s), the reference signal configuration(s), and/or the SpCell configuration(s), the network node 110 may indicate a respective configuration ID (e.g., a measurement configuration ID, a measurement reporting configuration ID, a reference signal configuration ID, and/or an SpCell configuration ID) that may be used by the UE 120 to identify the respective configuration. In some aspects, the network node 110 may transmit, in an RRC message, initial configuration information associated with a configured cell set.

As shown by reference number 630, the network node 110 and the UE 120 may communicate with one another based at least in part on a configured cell set. To illustrate, the network node 110 may transmit, and the UE 120 may receive, a downlink communication based at least in part on an activated cell set of the configured cell set. Alternatively or additionally, the UE 120 may transmit, and the network node 110 may receive, an uplink communication based at least in part on the activated cell set of the configured cell set.

As shown by reference number 640, the network node 110 may select a TRP group modification. As one example, the network node 110 may receive a signal metric (e.g., channel state information (CSI), RSSI, RSRQ, and/or CQI) that indicates that a current channel quality fails to meet a quality threshold and/or has poor quality. As another example, the network node 110 may identify that a location change of the UE satisfies a distance threshold associated with a changing channel quality. The network node 110 may select a TRP group modification that mitigates the poor and/or changing channel quality. As one example, the network node 110 may select, as at least part of the TRP group modification, a respective activation state for one or more TRP groups of multiple TRP groups included in a configured cell set. For instance, the network node 110 may select the inclusion or exclusion of one or more TRP groups in an activated cell group of the configured cell set. Alternatively or additionally, the network node 110 may select, as at least part of the TRP group modification, to change a primary TRP group of the activated cell group from a first TRP group to a second TRP group. In some aspects, the network node 110 may select, as part of the TRP group modification, an SpCell TRP group modification. To illustrate, the network node may select modification to an SpCell TRP group within a current primary TRP group of the activated cell group, such as a modification that changes the SpCell TRP group from a first TRP group to a second TRP group of the multiple TRP groups.

As shown by reference number 650, a network node 110 may transmit, and a UE 120 may receive, an indication of the TRP group modification. As further described herein, the network node 110 may transmit the TRP group modification using L1 signaling (e.g., DCI) or L2 signaling (e.g., a MAC CE). To illustrate, the network node 110 may transmit a TRP group activation MAC CE (e.g., the TRP group activation MAC CE 506) based at least in part on a first communication to the UE 120 and/or a primary TRP group configuration MAC CE (e.g., the primary TRP group configuration MAC CE 516) to the UE 120 based at least in part on a second communication to the UE 120. As another example, the network node 110 may transmit a joint TRP group activation and primary TRP group configuration MAC CE (e.g., the joint MAC CE 526) to the UE 120 in a single communication.

As shown by reference number 660, the network node 110 and the UE 120 may communicate with one another based at least in part on the TRP group modification. To illustrate, the network node 110 may transmit, and the UE 120 may receive, a downlink communication based at least in part on an activated cell set of the configured cell set that is configured based at least in part on the TRP group modification. Alternatively or additionally, the UE 120 may transmit, and the network node 110 may receive, an uplink communication based at least in part on the activated cell set that is configured based at least in part on the TRP group modification.

As shown by reference number 670, the network node 110 may iteratively select an updated TRP group modification, indicate the updated TRP group modification to the UE 120, and/or communicate with the UE 120 based at least in part on the updated TRP group modification. As one example, the network node 110 may receive an updated signal metric (e.g., CSI, RSSI, RSRQ, and/or CQI) that indicates that the current channel quality fails to meet the quality threshold and/or has poor quality. The network node 110 may select an updated TRP group modification to mitigate the poor quality. As another example, the network node 110 may identify that an updated location change of the UE satisfies the distance threshold associated with changing channel quality, and select an updated TRP group modification to mitigate the changing channel quality.

The ability to signal an indication of a TRP group modification in L1 signaling and/or L2 signaling reduces a delay in a UE applying the TRP group modification, relative to L3 signaling that indicates the TRP group modification. Reducing the delay improves a responsiveness of the UE in applying the TRP group modification, and reduces a probability that the TRP group modification applied by the UE is outdated. Applying a current (and relevant) TRP group modification instead of an outdated TRP group modification may improve a signal quality associated with UE communications, reduce recovery errors, and/or reduce data transfer delays.

As indicated above, FIG. 6 is provided as an example. Other examples may differ from what is described with regard to FIG. 6.

FIG. 7 is a diagram illustrating an example process 700 performed, for example, by a network node, in accordance with the present disclosure. Example process 700 is an example where the network node (e.g., network node 110 performs operations associated with TRP group activation and deactivation using L1 or L2 signaling).

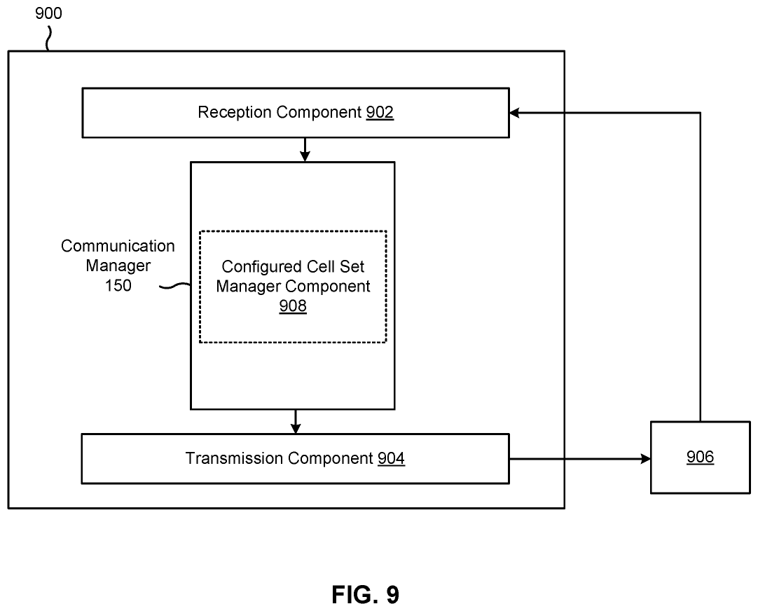

As shown in FIG. 7, in some aspects, process 700 may include selecting, for a configured cell set that includes multiple TRP groups, a TRP group modification associated with a cell group of the configured cell set (block 710). For example, the network node (e.g., using communication manager 150 and/or configured cell set manager component 908, depicted in FIG. 9) may select, for a configured cell set that includes multiple TRP groups, a TRP group modification associated with a cell group of the configured cell set, as described above. In some aspects, the cell group may be an activated cell group of the configured cell set.

As further shown in FIG. 7, in some aspects, process 700 may include transmitting the TRP group modification in at least one of L1 signaling or L2 signaling (block 720). For example, the network node (e.g., using communication manager 150 and/or transmission component 904, depicted in FIG. 9) may transmit the TRP group modification in at least one of L1 signaling or L2 signaling, as described above.

Process 700 may include additional aspects, such as any single aspect or any combination of aspects described below and/or in connection with one or more other processes described elsewhere herein.

In a first aspect, the L1 signaling or the L2 signaling includes at least one of a TRP group activation MAC CE, a primary TRP group configuration MAC CE, a joint TRP group activation and primary TRP group configuration MAC CE, or DCI.

In a second aspect, selecting the TRP group modification includes selecting a respective activation state for each TRP group of the multiple TRP groups.

In a third aspect, selecting the respective activation state includes selecting an inclusion or an exclusion of a respective TRP group of the multiple TRP groups in the activated cell group.

In a fourth aspect, the L1 signaling or the L2 signaling indicates an activation state field that indicates the respective activation state for each TRP group of the multiple TRP groups.

In a fifth aspect, the activation state field includes a bit field, each bit of the bit field is associated with a respective TRP group of the multiple TRP groups, and process 700 includes setting each bit of the activation state field to a respective value that indicates the respective activation state associated with the respective TRP group.

In a sixth aspect, a first bit state indicates an enabled activated state and a second bit state indicates a disabled activated state.

In a seventh aspect, each bit is associated with a respective TRP group identifier.

In an eighth aspect, the L1 signaling or the L2 signaling indicates a TRP group identifier associated with an activated TRP group of the multiple TRP groups.

In a ninth aspect, the TRP group modification includes deactivating a first TRP group of the multiple TRP groups, and the L1 signaling or the L2 signaling indicates a measurement configuration field that specifies at least one of an L1 measurement configuration associated with an L1 measurement that is based at least in part on the first TRP group, or a L1 measurement reporting configuration associated with reporting the L1 measurement.

In a tenth aspect, the L1 signaling or the L2 signaling indicates, for a reserved bit, a measurement inclusion state value that specifies that the L1 signaling or the L2 signaling includes the measurement configuration field.

In an eleventh aspect, the L1 signaling or the L2 signaling indicates multiple measurement configuration fields, and each measurement configuration field of the multiple measurement configuration fields is associated with a respective deactivated TRP group of the multiple TRP groups.

In a twelfth aspect, the L1 signaling or the L2 signaling indicates the multiple measurement configuration fields using an order that is based at least in part on a respective TRP group identifier of each deactivated TRP group of the multiple TRP groups.

In a thirteenth aspect, the order is based at least in part on increasing numeric values.

In a fourteenth aspect, each measurement configuration field indicates a respective L1 configuration that specifies an association between at least two TRPs that are included in the respective deactivated TRP group.

In a fifteenth aspect, the L1 signaling or the L2 signaling indicates a respective reference signal identifier field for each deactivated TRP group of the multiple TRP groups.

In a sixteenth aspect, the L1 signaling or the L2 signaling indicates a respective reference signal configuration for each activated TRP group of the multiple TRP groups.

In a seventeenth aspect, the respective reference signal identifier field includes an eight-bit field.

In an eighteenth aspect, the L1 signaling or L2 signaling indicates a number of activated TRP groups of the multiple TRP groups, and the number of activated TRP groups is based at least in part on at least one of a first maximum number of activated cell groups specified by a communication standard, a second maximum number of available TRP groups, or a third maximum number of activated TRP groups supported by a UE.

In a nineteenth aspect, selecting the TRP group modification includes selecting to change a primary TRP group of the activated cell group from a first TRP group of the multiple TRP groups to a second TRP group of the multiple TRP groups.

In a twentieth aspect, the L1 signaling or the L2 signaling indicates to activate the second TRP group as the primary TRP group.

In a twenty-first aspect, the L1 signaling or the L2 signaling indicates an explicit instruction to deactivate the first TRP group as the primary TRP group, or an implicit instruction to deactivate the first TRP group as the primary TRP group.

In a twenty-second aspect, the L1 signaling or the L2 signaling indicates, for the second TRP group, an enabled activation state.

In a twenty-third aspect, the L1 signaling or the L2 signaling indicates at least one of a primary TRP group identifier, an SpCell TRP group identifier, an SpCell configuration, a TCI state associated with an activated SpCell, a reference signal associated with a beam management procedure, a L1 measurement configuration for a deactivated TRP group of the one or more TRP groups, or a L1 reporting configuration for reporting a L1 measurement associated with the L1 measurement configuration.

In a twenty-fourth aspect, the primary TRP group identifier includes at least one of a pointer to the primary TRP group identifier, or a bit in a bitmap.

In a twenty-fifth aspect, the SpCell TRP group identifier includes at least one of a pointer to a TRP group identifier associated with a TRP group of the multiple TRP groups to activate as an SpCell, or an index of the TRP group to activate as the SpCell.

In a twenty-sixth aspect, the SpCell configuration includes at least one of a pointer to the SpCell configuration, or a bit in a bitmap.

In a twenty-seventh aspect, the SpCell configuration indicates one of multiple SpCell configurations supported by a UE.

In a twenty-eighth aspect, the SpCell configuration is based at least in part on an octet of bits indicated by the L1 signaling or the L2 signaling.

In a twenty-ninth aspect, the L1 signaling or the L2 signaling indicates a logical channel identifier that is specific to an activation state associated with a cell group.

In a thirtieth aspect, the TCI state indicates to activate the TCI state for the SpCell TRP group based at least in part on the beam management procedure.

In a thirty-first aspect, the L1 signaling or the L2 signaling conditionally refrains from indicating the reference signal based at least in part on the SpCell TRP group having an enabled activation state.

In a thirty-second aspect, the L1 signaling or the L2 signaling conditionally indicates the reference signal based at least in part on the SpCell TRP group having a disabled activation state.

In a thirty-third aspect, the L1 signaling or the L2 signaling indicates the primary TRP group identifier, the SpCell TRP group identifier, and the SpCell configuration based at least in part on using a single octet of bits.

In a thirty-fourth aspect, the L1 signaling or the L2 signaling indicates the primary TRP group identifier, the SpCell TRP group identifier, and the SpCell configuration based at least in part on using a first octet of bits for the primary TRP group identifier, a second octet of bits for the SpCell TRP group identifier, and a third octet of bits for the SpCell configuration.

In a thirty-fifth aspect, at least one of the first octet of bits, the second octet of bits, or the third octet of bits includes a reserved bit.

In a thirty-sixth aspect, selecting the TRP group modification includes selecting a modification to an SpCell TRP group within a primary TRP group of the activated cell group from a first TRP group of the multiple TRP groups to a second TRP group of the multiple TRP groups.

In a thirty-seventh aspect, the TRP group modification includes a TRP group activation state modification and a primary TRP group modification, and the L1 signaling or L2 signaling indicates the TRP group modification in a single L1 message or a single L2 message.

In a thirty-eighth aspect, the L1 signaling or the L2 signaling indicates, as at least part of the single L1 message or the single L2 message, an SpCell TRP group modification.

In a thirty-ninth aspect, the TRP group modification includes a TRP group activation state modification and excludes a primary TRP group modification, and the L1 signaling or L2 signaling indicates the TRP group modification in a single L1 message or a single L2 message based at least in part on conditionally excluding one or more fields within the single L1 message or the single L2 message that are associated with the primary TRP group modification.

In a fortieth aspect, the L1 signaling or the L2 signaling indicates that the TRP group modification excludes the one or more fields that are associated with the primary TRP group modification.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by UE, in accordance with the present disclosure. Example process 800 is an example where the UE (e.g., UE 120) performs operations associated with TRP group activation and deactivation using L1 or L2 signaling.

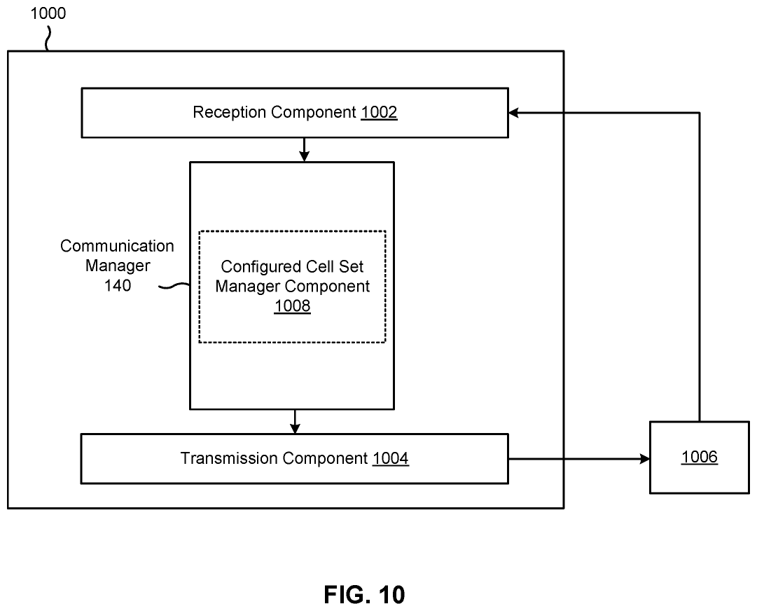

As shown in FIG. 8, in some aspects, process 800 may include receiving, in at least one of L1 signaling or L2 signaling, an indication of a TRP group modification that is associated with a cell group of a configured cell set that includes multiple TRP groups (block 810). In some aspects, the cell group may be an activated cell group of the configured cell set. For example, the UE (e.g., using communication manager 140 and/or reception component 1002, depicted in FIG. 10) may receive, in at least one of L1 signaling or L2 signaling, an indication of a TRP group modification that is associated with a cell group of a configured cell set that includes multiple TRP groups, as described above.

As further shown in FIG. 8, in some aspects, process 800 may include communicating in a wireless network based at least in part on the TRP group modification (block 820). For example, the UE (e.g., using communication manager 140 and/or configured cell set manager component 1008, depicted in FIG. 10) may communicate in a wireless network based at least in part on the TRP group modification, as described above.

Process 800 may include additional aspects, such as any single aspect or any combination of aspects described below and/or in connection with one or more other processes described elsewhere herein.

In a first aspect, the L1 signaling or the L2 signaling includes at least one of a TRP group activation MAC CE, a primary TRP group configuration MAC CE, a joint TRP group activation and primary TRP group configuration MAC CE, or DCI.

In a second aspect, the TRP group modification includes a respective activation state for each TRP group of the multiple TRP groups.

In a third aspect, the L1 signaling or the L2 signaling indicates an activation state field that indicates the respective activation state for each TRP group of the multiple TRP groups.

In a fourth aspect, the activation state field includes a bit field, each bit of the bit field is associated with a respective TRP group of the multiple TRP groups, and each bit of the activation state field indicates the respective activation state associated with the respective TRP group.

In a fifth aspect, a first bit state indicates an enabled activated state and a second bit state indicates a disabled activated state.

In a sixth aspect, each bit is associated with a respective TRP group identifier.

In a seventh aspect, the L1 signaling or the L2 signaling indicates a TRP group identifier associated with an activated TRP group of the multiple TRP groups.

In an eighth aspect, the TRP group modification includes deactivating a first TRP group of the multiple TRP groups, and the L1 signaling or the L2 signaling indicates a measurement configuration field that specifies at least one of an L1 measurement configuration associated with an L1 measurement that is based at least in part on the first TRP group, or an L1 measurement reporting configuration associated with reporting the L1 measurement.

In a ninth aspect, the L1 signaling or the L2 signaling indicates, for a reserved bit, a measurement inclusion state value that specifies that the L1 signaling or the L2 signaling includes the measurement configuration field.

In a tenth aspect, the L1 signaling or the L2 signaling indicates multiple measurement configuration fields, and each measurement configuration field of the multiple measurement configuration fields is associated with a respective deactivated TRP group of the multiple TRP groups.

In an eleventh aspect, the L1 signaling or the L2 signaling indicates the multiple measurement configuration fields using an order that is based at least in part on a respective TRP group identifier of each deactivated TRP group of the multiple TRP groups.

In a twelfth aspect, the order is based at least in part on increasing numeric values.

In a thirteenth aspect, each measurement configuration field indicates a respective L1 configuration that specifies an association between at least two TRPs that are included in the respective deactivated TRP group.

In a fourteenth aspect, the L1 signaling or the L2 signaling indicates a respective reference signal identifier field for each deactivated TRP group of the multiple TRP groups.

In a fifteenth aspect, the L1 signaling or the L2 signaling indicates a respective reference signal configuration for each activated TRP group of the multiple TRP groups.

In a sixteenth aspect, the respective reference signal identifier field includes an eight-bit field.

In a seventeenth aspect, the L1 signaling or L2 signaling indicates a number of activated TRP groups of the multiple TRP groups, and the number of activated TRP groups is based at least in part on at least one of a first maximum number of activated cell groups specified by a communication standard, a second maximum number of available TRP groups, or a third maximum number of activated TRP groups supported by the UE.

In an eighteenth aspect, the TRP group modification includes a change to a primary TRP group of the activated cell group from a first TRP group of the multiple TRP groups as the primary TRP group to a second TRP group of the multiple TRP groups as the primary TRP group.

In a nineteenth aspect, the L1 signaling or the L2 signaling indicates to activate the second TRP group as the primary TRP group.

In a twentieth aspect, the L1 signaling or the L2 signaling indicates an explicit instruction to deactivate the first TRP group as the primary TRP group, or an implicit instruction to deactivate the first TRP group as the primary TRP group.

In a twenty-first aspect, the L1 signaling or the L2 signaling indicates, for the second TRP group, an enabled activation state.

In a twenty-second aspect, the L1 signaling or the L2 signaling indicates at least one of a primary TRP group identifier, an SpCell TRP group identifier, an SpCell configuration, a TCI state associated with an activated SpCell, a reference signal associated with a beam management procedure, an L1 measurement configuration for a deactivated TRP group of the one or more TRP groups, or an L1 reporting configuration for reporting an L1 measurement associated with the L1 measurement configuration.

In a twenty-third aspect, the primary TRP group identifier includes at least one of a pointer to the primary TRP group identifier, or a bit in a bitmap.

In a twenty-fourth aspect, the SpCell TRP group identifier includes at least one of a pointer to a TRP group identifier associated with a TRP group, of the multiple TRP groups, to activate as an SpCell, or an index of the TRP group to activate as the SpCell.

In a twenty-fifth aspect, the SpCell configuration includes at least one of a pointer to the SpCell configuration, or a bit in a bitmap.

In a twenty-sixth aspect, the SpCell configuration indicates one of multiple SpCell configurations supported by a UE.

In a twenty-seventh aspect, the SpCell configuration is based at least in part on an octet of bits indicated by the L1 signaling or the L2 signaling.

In a twenty-eighth aspect, the L1 signaling or the L2 signaling indicates a logical channel identifier that is specific to an activation state associated with a cell group.

In a twenty-ninth aspect, the TCI state indicates to activate the TCI state for the SpCell TRP group based at least in part on the beam management procedure.

In a thirtieth aspect, the L1 signaling or the L2 signaling conditionally refrains from indicating the reference signal based at least in part on the SpCell TRP group having an enabled activation state.

In a thirty-first aspect, the L1 signaling or the L2 signaling conditionally indicates the reference signal based at least in part on the SpCell TRP group having a disabled activation state.

In a thirty-second aspect, the L1 signaling or the L2 signaling indicates the primary TRP group identifier, the SpCell TRP group identifier, and the SpCell configuration based at least in part on using a single octet of bits.

In a thirty-third aspect, the L1 signaling or the L2 signaling indicates the primary TRP group identifier, the SpCell TRP group identifier, and the SpCell configuration based at least in part on using a first octet of bits for the primary TRP group identifier, a second octet of bits for the SpCell TRP group identifier, and a third octet of bits for the SpCell configuration.

In a thirty-fourth aspect, at least one of the first octet of bits, the second octet of bits, or the third octet of bits includes a reserved bit.

In a thirty-fifth aspect, the TRP group modification includes a change to an SpCell TRP group within a primary TRP group of the activated cell group from a first TRP group of the multiple TRP groups to a second TRP group of the multiple TRP groups.

In a thirty-sixth aspect, the TRP group modification includes a TRP group activation state modification and a primary TRP group modification, and the L1 signaling or L2 signaling indicates the TRP group modification in a single L1 message or a single L2 message.

In a thirty-seventh aspect, the L1 signaling or the L2 signaling indicates, as at least part of the single L1 message or the single L2 message, an SpCell TRP group modification.

In a thirty-eighth aspect, the TRP group modification includes a TRP group activation state modification and excludes a primary TRP group modification, and the L1 signaling or L2 signaling indicates the TRP group modification in a single L1 message or a single L2 message based at least in part on conditionally excluding one or more fields within the single L1 message or the single L2 message that are associated with the primary TRP group modification.

In a thirty-ninth aspect, the L1 signaling or the L2 signaling indicates that the TRP group modification excludes the one or more fields that are associated with the primary TRP group modification.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include one or more of a configured cell set manager component 908, among other examples.

In some aspects, the apparatus 900 may be configured to perform one or more operations described herein in connection with FIGS. 5-8. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, one or more memories, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, one or more memories, or a combination thereof, of the network node described in connection with FIG. 2. In some aspects, the transmission component 904 may be co-located with the reception component 902 in a transceiver.

The configured cell set manager component 908 may select, for a configured cell set that includes multiple TRP groups, a TRP group modification associated with a cell group of the configured cell set. In some aspects, the cell group may be an activated cell group of the configured cell set. The transmission component 904 may transmit the TRP group modification in at least one of L1 signaling or L2 signaling.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a configured cell set manager component 1008, among other examples.

In some aspects, the apparatus 1000 may be configured to perform one or more operations described herein in connection with FIGS. 5-8. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, one or more memories, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, one or more memories, or a combination thereof, of the UE described in connection with FIG. 2. In some aspects, the transmission component 1004 may be co-located with the reception component 1002 in a transceiver.

The reception component 1002 may receive, in at least one of L1 signaling or L2 signaling, an indication of a TRP group modification that is associated with a cell group of a configured cell set that includes multiple TRP groups. In some aspects, the cell group may be an activated cell group of the configured cell set. The configured cell set manager component 1008 may communicate in a wireless network based at least in part on the TRP group modification.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by an apparatus of a network node comprising: selecting, for a configured cell set that includes multiple transmit-receive point (TRP) groups, a TRP group modification associated with a cell group of the configured cell set; and transmitting the TRP group modification in at least one of layer 1 signaling or layer 2 signaling.

Aspect 2: The method of Aspect 1, wherein the layer 1 signaling or the layer 2 signaling comprises at least one of: a TRP group activation medium access control (MAC) control element (CE), a primary TRP group configuration MAC CE, a joint TRP group activation and primary TRP group configuration MAC CE, or downlink control information (DCI).

Aspect 3: The method of Aspect 1 or Aspect 2, wherein selecting the TRP group modification comprises: selecting a respective activation state for each TRP group of the multiple TRP groups.

Aspect 4: The method of Aspect 3, wherein selecting the respective activation state comprises: selecting an inclusion or an exclusion of a respective TRP group of the multiple TRP groups in the activated cell group.

Aspect 5: The method of Aspect 3 or Aspect 4, wherein the layer 1 signaling or the layer 2 signaling indicates an activation state field that indicates the respective activation state for each TRP group of the multiple TRP groups.

Aspect 6: The method of Aspect 5, wherein the activation state field comprises a bit field, wherein each bit of the bit field is associated with a respective TRP group of the multiple TRP groups, and the method further comprises: setting each bit of the activation state field to a respective value that indicates the respective activation state associated with the respective TRP group.

Aspect 7: The method of Aspect 6, wherein a first bit state indicates an enabled activated state and a second bit state indicates a disabled activated state.

Aspect 8: The method of Aspect 6 or Aspect 7, wherein each bit is associated with a respective TRP group identifier.

Aspect 9: The method of any one of Aspects 5-8, wherein the layer 1 signaling or the layer 2 signaling indicates a TRP group identifier associated with an activated TRP group of the multiple TRP groups.

Aspect 10: The method of any one of Aspects 5-9, wherein the TRP group modification includes deactivating a first TRP group of the multiple TRP groups, and wherein the layer 1 signaling or the layer 2 signaling indicates a measurement configuration field that specifies at least one of: a layer 1 measurement configuration associated with a layer 1 measurement that is based at least in part on the first TRP group, or a layer 1 measurement reporting configuration associated with reporting the layer 1 measurement.

Aspect 11: The method of Aspect 10, wherein the layer 1 signaling or the layer 2 signaling indicates, for a reserved bit, a measurement inclusion state value that specifies that the layer 1 or the layer 2 signaling includes the measurement configuration field.

Aspect 12: The method of Aspect 10 or Aspect 11, wherein the layer 1 signaling or the layer 2 signaling indicates multiple measurement configuration fields, wherein each measurement configuration field of the multiple measurement configuration fields is associated with a respective deactivated TRP group of the multiple TRP groups.

Aspect 13: The method of Aspect 12, wherein the layer 1 signaling or the layer 2 signaling indicates the multiple measurement configuration fields using an order that is based at least in part on a respective TRP group identifier of each deactivated TRP group of the multiple TRP groups.

Aspect 14: The method of Aspect 13, wherein the order is based at least in part on increasing numeric values.

Aspect 15: The method of any one of Aspects 12-14, wherein each measurement configuration field indicates a respective layer 1 configuration that specifies an association between at least two TRPs that are included in the respective deactivated TRP group.

Aspect 16: The method of any one of Aspects 10-15, wherein the layer 1 signaling or the layer 2 signaling indicates a respective reference signal identifier field for each deactivated TRP group of the multiple TRP groups.

Aspect 17: The method of Aspect 16, wherein the layer 1 signaling or the layer 2 signaling indicates a respective reference signal configuration for each activated TRP group of the multiple TRP groups.

Aspect 18: The method of Aspect 16 or Aspect 17, wherein the respective reference signal identifier field comprises an eight-bit field.

Aspect 19: The method of any one of Aspects 3-18, wherein the layer 1 signaling or layer 2 signaling indicates a number of activated TRP groups of the multiple TRP groups, wherein the number of activated TRP groups is based at least in part on at least one of: a first maximum number of activated cell groups specified by a communication standard, a second maximum number of available TRP groups, or a third maximum number of activated TRP groups supported by a user equipment (UE).

Aspect 20: The method of any one of Aspects 1-19, wherein selecting the TRP group modification comprises: selecting to change a primary TRP group of the activated cell group from a first TRP group of the multiple TRP groups to a second TRP group of the multiple TRP groups.

Aspect 21: The method of Aspect 20, wherein the layer 1 signaling or the layer 2 signaling indicates to activate the second TRP group as the primary TRP group.

Aspect 22: The method of Aspect 21, wherein the layer 1 signaling or the layer 2 signaling indicates: an explicit instruction to deactivate the first TRP group as the primary TRP group, or an implicit instruction to deactivate the first TRP group as the primary TRP group.

Aspect 23: The method of any one of Aspects 20-22, wherein the layer 1 signaling or the layer 2 signaling indicates, for the second TRP group, an enabled activation state.

Aspect 24: The method of any one of Aspects 20-23, wherein the layer 1 signaling or the layer 2 signaling indicates at least one of: a primary TRP group identifier, a special cell (SpCell) TRP group identifier, an SpCell configuration, a transmission configuration indicator (TCI) state associated with an activated SpCell, a reference signal associated with a beam management procedure, a layer 1 measurement configuration for a deactivated TRP group of the one or more TRP groups, or a layer 1 reporting configuration for reporting a layer 1 measurement associated with the layer 1 measurement configuration.

Aspect 25: The method of Aspect 24, wherein the primary TRP group identifier comprises at least one of: a pointer to the primary TRP group identifier, or a bit in a bitmap.

Aspect 26: The method of Aspect 24 or Aspect 25, wherein the SpCell TRP group identifier comprises at least one of: a pointer to a TRP group identifier associated with a TRP group of the multiple TRP groups to activate as an SpCell, or an index of the TRP group to activate as the SpCell.

Aspect 27: The method of any one of Aspects 24-26, wherein the SpCell configuration comprises at least one of: a pointer to the SpCell configuration, or a bit in a bitmap.

Aspect 28: The method of Aspect 27, wherein the SpCell configuration indicates one of multiple SpCell configurations supported by a user equipment (UE).

Aspect 29: The method of any one of Aspects 24-28, wherein the SpCell configuration is based at least in part on an octet of bits indicated by the layer 1 signaling or the layer 2 signaling.

Aspect 30: The method of any one of Aspects 24-29, wherein the layer 1 signaling or the layer 2 signaling indicates a logical channel identifier that is specific to an activation state associated with a cell group.

Aspect 31: The method of any one of Aspects 24-30, wherein the TCI state indicates to activate the TCI state for the SpCell TRP group based at least in part on the beam management procedure.

Aspect 32: The method of any one of Aspects 24-31, wherein the layer 1 signaling or the layer 2 signaling conditionally refrains from indicating the reference signal based at least in part on the SpCell TRP group having an enabled activation state.

Aspect 33: The method of any one of Aspects 24-32, wherein the layer 1 signaling or the layer 2 signaling conditionally indicates the reference signal based at least in part on the SpCell TRP group having a disabled activation state.

Aspect 34: The method of any one of Aspects 24-33, wherein the layer 1 signaling or the layer 2 signaling indicates the primary TRP group identifier, the SpCell TRP group identifier, and the SpCell configuration based at least in part on using a single octet of bits.

Aspect 35: The method of any one of Aspects 24-34, wherein the layer 1 signaling or the layer 2 signaling indicates the primary TRP group identifier, the SpCell TRP group identifier, and the SpCell configuration based at least in part on using: a first octet of bits for the primary TRP group identifier, a second octet of bits for the SpCell TRP group identifier, and a third octet of bits for the SpCell configuration.

Aspect 36: The method of Aspect 35, wherein at least one of the first octet of bits, the second octet of bits, or the third octet of bits includes a reserved bit.

Aspect 37: The method of any one of Aspects 1-36, wherein selecting the TRP group modification comprises: selecting a modification to an SpCell TRP group within a primary TRP group of the activated cell group from a first TRP group of the multiple TRP groups to a second TRP group of the multiple TRP groups.

Aspect 38: The method of any one of Aspects 1-37, wherein the TRP group modification comprises a TRP group activation state modification and a primary TRP group modification, and wherein the layer 1 signaling or layer 2 signaling indicates the TRP group modification in a single layer 1 message or a single layer 2 message.

Aspect 39: The method of Aspect 38, wherein the layer 1 signaling or the layer 2 signaling indicates, as at least part of the single layer 1 message or the single layer 2 message, an SpCell TRP group modification.

Aspect 40: The method of any one of Aspects 1-39, wherein the TRP group modification comprises a TRP group activation state modification and excludes a primary TRP group modification, and wherein the layer 1 signaling or layer 2 signaling indicates the TRP group modification in a single layer 1 message or a single layer 2 message based at least in part on conditionally excluding one or more fields within the single layer 1 message or the single layer 2 message that are associated with the primary TRP group modification.

Aspect 41: The method of Aspect 40, wherein the layer 1 signaling or the layer 2 signaling indicates that the TRP group modification excludes the one or more fields that are associated with the primary TRP group modification.

Aspect 42: A method of wireless communication performed by an apparatus of a user equipment (UE) comprising: receiving, in at least one of layer 1 signaling or layer 2 signaling, an indication of a transmit-receive point (TRP) group modification that is associated with a cell group of a configured cell set that includes multiple TRP groups; and communicating in a wireless network based at least in part on the TRP group modification.

Aspect 43: The method of Aspect 42, wherein the layer 1 signaling or the layer 2 signaling comprises at least one of: a TRP group activation medium access control (MAC) control element (CE), a primary TRP group configuration MAC CE, a joint TRP group activation and primary TRP group configuration MAC CE, or downlink control information (DCI).

Aspect 44: The method of Aspect 42 or Aspect 43, wherein the TRP group modification comprises a respective activation state for each TRP group of the multiple TRP groups.

Aspect 45: The method of Aspect 44, wherein the layer 1 signaling or the layer 2 signaling indicates an activation state field that indicates the respective activation state for each TRP group of the multiple TRP groups.

Aspect 46: The method of Aspect 45, wherein the activation state field comprises a bit field, each bit of the bit field is associated with a respective TRP group of the multiple TRP groups, and each bit of the activation state field indicates the respective activation state associated with the respective TRP group.

Aspect 47: The method of Aspect 46, wherein a first bit state indicates an enabled activated state and a second bit state indicates a disabled activated state.

Aspect 48: The method of Aspect 46 or Aspect 47, wherein each bit is associated with a respective TRP group identifier.

Aspect 49: The method of any one of Aspects 45-48, wherein the layer 1 signaling or the layer 2 signaling indicates a TRP group identifier associated with an activated TRP group of the multiple TRP groups.

Aspect 50: The method of any one of Aspects 45-49, wherein the TRP group modification includes deactivating a first TRP group of the multiple TRP groups, and wherein the layer 1 signaling or the layer 2 signaling indicates a measurement configuration field that specifies at least one of: a layer 1 measurement configuration associated with a layer 1 measurement that is based at least in part on the first TRP group, or a layer 1 measurement reporting configuration associated with reporting the layer 1 measurement.

Aspect 51: The method of Aspect 50, wherein the layer 1 signaling or the layer 2 signaling indicates, for a reserved bit, a measurement inclusion state value that specifies that the layer 1 or the layer 2 signaling includes the measurement configuration field.

Aspect 52: The method of Aspect 50 or Aspect 51, wherein the layer 1 signaling or the layer 2 signaling indicates multiple measurement configuration fields, wherein each measurement configuration field of the multiple measurement configuration fields is associated with a respective deactivated TRP group of the multiple TRP groups.

Aspect 53: The method of Aspect 52, wherein the layer 1 signaling or the layer 2 signaling indicates the multiple measurement configuration fields using an order that is based at least in part on a respective TRP group identifier of each deactivated TRP group of the multiple TRP groups.

Aspect 54: The method of Aspect 53, wherein the order is based at least in part on increasing numeric values.

Aspect 55: The method of any one of Aspects 52-54, wherein each measurement configuration field indicates a respective layer 1 configuration that specifies an association between at least two TRPs that are included in the respective deactivated TRP group.

Aspect 56: The method of any one of Aspects 50-55, wherein the layer 1 signaling or the layer 2 signaling indicates a respective reference signal identifier field for each deactivated TRP group of the multiple TRP groups.

Aspect 57: The method of Aspect 56, wherein the layer 1 signaling or the layer 2 signaling indicates a respective reference signal configuration for each activated TRP group of the multiple TRP groups.

Aspect 58: The method of Aspect 56 or Aspect 57, wherein the respective reference signal identifier field comprises an eight-bit field.

Aspect 59: The method of any one of Aspects 44-58, wherein the layer 1 signaling or layer 2 signaling indicates a number of activated TRP groups of the multiple TRP groups, wherein the number of activated TRP groups is based at least in part on at least one of: a first maximum number of activated cell groups specified by a communication standard, a second maximum number of available TRP groups, or a third maximum number of activated TRP groups supported by the UE.

Aspect 60: The method of any one of Aspects 42-59, wherein the TRP group modification comprises a change to a primary TRP group of the activated cell group from a first TRP group of the multiple TRP groups as the primary TRP group to a second TRP group of the multiple TRP groups as the primary TRP group.

Aspect 61: The method of Aspect 60, wherein the layer 1 signaling or the layer 2 signaling indicates to activate the second TRP group as the primary TRP group.

Aspect 62: The method of Aspect 61, wherein the layer 1 signaling or the layer 2 signaling indicates: an explicit instruction to deactivate the first TRP group as the primary TRP group, or an implicit instruction to deactivate the first TRP group as the primary TRP group.

Aspect 63: The method of any one of Aspects 60-62, wherein the layer 1 signaling or the layer 2 signaling indicates, for the second TRP group, an enabled activation state.

Aspect 64: The method of any one of Aspects 60-63, wherein the layer 1 signaling or the layer 2 signaling indicates at least one of: a primary TRP group identifier, a special cell (SpCell) TRP group identifier, an SpCell configuration, a transmission configuration indicator (TCI) state associated with an activated SpCell, a reference signal associated with a beam management procedure, a layer 1 measurement configuration for a deactivated TRP group of the one or more TRP groups, or a layer 1 reporting configuration for reporting a layer 1 measurement associated with the layer 1 measurement configuration.

Aspect 65: The method of Aspect 64, wherein the primary TRP group identifier comprises at least one of: a pointer to the primary TRP group identifier, or a bit in a bitmap.

Aspect 66: The method of Aspect 64 or Aspect 65, wherein the SpCell TRP group identifier comprises at least one of: a pointer to a TRP group identifier associated with a TRP group, of the multiple TRP groups, to activate as an SpCell, or an index of the TRP group to activate as the SpCell.

Aspect 67: The method of any one of Aspects 64-66, wherein the SpCell configuration comprises at least one of: a pointer to the SpCell configuration, or a bit in a bitmap.

Aspect 68: The method of Aspect 67, wherein the SpCell configuration indicates one of multiple SpCell configurations supported by a user equipment (UE).

Aspect 69: The method of any one of Aspects 64-68, wherein the SpCell configuration is based at least in part on an octet of bits indicated by the layer 1 signaling or the layer 2 signaling.

Aspect 70: The method of any one of Aspects 64-69, wherein the layer 1 signaling or the layer 2 signaling indicates a logical channel identifier that is specific to an activation state associated with a cell group.

Aspect 71: The method of any one of Aspects 64-70, wherein the TCI state indicates to activate the TCI state for the SpCell TRP group based at least in part on the beam management procedure.

Aspect 72: The method of any one of Aspects 64-71, wherein the layer 1 signaling or the layer 2 signaling conditionally refrains from indicating the reference signal based at least in part on the SpCell TRP group having an enabled activation state.

Aspect 73: The method of any one of Aspects 64-72, wherein the layer 1 signaling or the layer 2 signaling conditionally indicates the reference signal based at least in part on the SpCell TRP group having a disabled activation state.

Aspect 74: The method of any one of Aspects 64-73, wherein the layer 1 signaling or the layer 2 signaling indicates the primary TRP group identifier, the SpCell TRP group identifier, and the SpCell configuration based at least in part on using a single octet of bits.

Aspect 75: The method of any one of Aspects 64-74, wherein the layer 1 signaling or the layer 2 signaling indicates the primary TRP group identifier, the SpCell TRP group identifier, and the SpCell configuration based at least in part on using: a first octet of bits for the primary TRP group identifier, a second octet of bits for the SpCell TRP group identifier, and a third octet of bits for the SpCell configuration.

Aspect 76: The method of Aspect 75, wherein at least one of the first octet of bits, the second octet of bits, or the third octet of bits includes a reserved bit.

Aspect 77: The method of any one of Aspects 42-76, wherein the TRP group modification comprises a change to an SpCell TRP group within a primary TRP group of the activated cell group from a first TRP group of the multiple TRP groups to a second TRP group of the multiple TRP groups.

Aspect 78: The method of any one of Aspects 42-77, wherein the TRP group modification comprises a TRP group activation state modification and a primary TRP group modification, and wherein the layer 1 signaling or layer 2 signaling indicates the TRP group modification in a single layer 1 message or a single layer 2 message.

Aspect 79: The method of Aspect 78, wherein the layer 1 signaling or the layer 2 signaling indicates, as at least part of the single layer 1 message or the single layer 2 message, an SpCell TRP group modification.

Aspect 80: The method of any one of Aspects 42-79, wherein the TRP group modification comprises a TRP group activation state modification and excludes a primary TRP group modification, and wherein the layer 1 signaling or layer 2 signaling indicates the TRP group modification in a single layer 1 message or a single layer 2 message based at least in part on conditionally excluding one or more fields within the single layer 1 message or the single layer 2 message that are associated with the primary TRP group modification.

Aspect 81: The method of Aspect 80, wherein the layer 1 signaling or the layer 2 signaling indicates that the TRP group modification excludes the one or more fields that are associated with the primary TRP group modification.

Aspect 82: An apparatus for wireless communication at a device, comprising a processor; memory coupled with the processor; and instructions stored in the memory and executable by the processor to cause the apparatus to perform the method of one or more of Aspects 1-41.

Aspect 83: An apparatus for wireless communication at a device, comprising a processor; memory coupled with the processor; and instructions stored in the memory and executable by the processor to cause the apparatus to perform the method of one or more of Aspects 42-81.

Aspect 84: A device for wireless communication, comprising one or more memories and one or more processors coupled to the one or more memories, the one or more processors configured, individually or collectively, to perform the method of one or more of Aspects 1-41.

Aspect 85: A device for wireless communication, comprising one or more memories and one or more processors coupled to the one or more memories, the one or more processors configured, individually or collectively, to perform the method of one or more of Aspects 42-81.

Aspect 86: An apparatus for wireless communication, comprising at least one means for performing the method of one or more of Aspects 1-41.

Aspect 87: An apparatus for wireless communication, comprising at least one means for performing the method of one or more of Aspects 42-81.

Aspect 88: A non-transitory computer-readable medium storing code for wireless communication, the code comprising instructions executable by a processor to perform the method of one or more of Aspects 1-41.

Aspect 89: A non-transitory computer-readable medium storing code for wireless communication, the code comprising instructions executable by a processor to perform the method of one or more of Aspects 42-81.

Aspect 90: A non-transitory computer-readable medium storing a set of instructions for wireless communication, the set of instructions comprising one or more instructions that, when executed by one or more processors of a device, cause the device to perform the method of one or more of Aspects 1-41.

Aspect 91: A non-transitory computer-readable medium storing a set of instructions for wireless communication, the set of instructions comprising one or more instructions that, when executed by one or more processors of a device, cause the device to perform the method of one or more of Aspects 42-81.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a network node, comprising:
one or more memories; and
one or more processors, coupled to the one or more memories, configured to cause the network node to:
select, for a configured cell set that includes multiple transmit-receive point (TRP) groups, a TRP group modification associated with a cell group of the configured cell set; and
transmit the TRP group modification in at least one of layer 1 signaling or layer 2 signaling.

2. The apparatus of claim 1, wherein the layer 1 signaling or the layer 2 signaling comprises at least one of:
a TRP group activation medium access control (MAC) control element (CE),
a primary TRP group configuration MAC CE,
a joint TRP group activation and primary TRP group configuration MAC CE, or
downlink control information (DCI).

3. The apparatus of claim 1, wherein the one or more processors, to cause the network node to select the TRP group modification, are configured to cause the network node to:
select a respective activation state for each TRP group of the multiple TRP groups.

4. The apparatus of claim 3, wherein the layer 1 signaling or the layer 2 signaling indicates an activation state field that indicates the respective activation state for each TRP group of the multiple TRP groups.

5. The apparatus of claim 4, wherein the one or more processors are further configured to cause the network node to deactivate a first TRP group of the multiple TRP groups, and
wherein the layer 1 signaling or the layer 2 signaling indicates a measurement configuration field that specifies at least one of:
a layer 1 measurement configuration associated with a layer 1 measurement that is based at least in part on the first TRP group, or
a layer 1 measurement reporting configuration associated with reporting the layer 1 measurement.

6. The apparatus of claim 5, wherein the layer 1 signaling or the layer 2 signaling indicates, for a reserved bit, a measurement inclusion state value that specifies that the layer 1 or the layer 2 signaling includes the measurement configuration field.

7. The apparatus of claim 5, wherein the layer 1 signaling or the layer 2 signaling indicates multiple measurement configuration fields, wherein each measurement configuration field of the multiple measurement configuration fields is associated with a respective deactivated TRP group of the multiple TRP groups.

8. The apparatus of claim 5, wherein the layer 1 signaling or the layer 2 signaling indicates a respective reference signal identifier field for each deactivated TRP group of the multiple TRP groups.

9. The apparatus of claim 3, wherein the layer 1 signaling or layer 2 signaling indicates a number of activated TRP groups of the multiple TRP groups, wherein the number of activated TRP groups is based at least in part on at least one of:
a first maximum number of activated cell groups specified by a communication standard,
a second maximum number of available TRP groups, or
a third maximum number of activated TRP groups supported by a user equipment (UE).

10. The apparatus of claim 1, wherein the one or more processors, to cause the network node to select the TRP group modification, are configured to cause the network node to:
select to change a primary TRP group of the activated cell group from a first TRP group of the multiple TRP groups to a second TRP group of the multiple TRP groups.

11. The apparatus of claim 10, wherein the layer 1 signaling or the layer 2 signaling indicates at least one of:
a primary TRP group identifier,
a special cell (SpCell) TRP group identifier,
an SpCell configuration,
a transmission configuration indicator (TCI) state associated with an activated SpCell,
a reference signal associated with a beam management procedure,
a layer 1 measurement configuration for a deactivated TRP group of the one or more TRP groups, or
a layer 1 reporting configuration for reporting a layer 1 measurement associated with the layer 1 measurement configuration.

12. The apparatus of claim 1, wherein the one or more processors, to cause the network node to select the TRP group modification, are configured to cause the network node to:
select a modification to an SpCell TRP group within a primary TRP group of the activated cell group from a first TRP group of the multiple TRP groups to a second TRP group of the multiple TRP groups.

13. The apparatus of claim 1, wherein the TRP group modification comprises a TRP group activation state modification and a primary TRP group modification, and
wherein the layer 1 signaling or layer 2 signaling indicates the TRP group modification in a single layer 1 message or a single layer 2 message.

14. The apparatus of claim 1, wherein the TRP group modification comprises a TRP group activation state modification and excludes a primary TRP group modification, and
wherein the layer 1 signaling or layer 2 signaling indicates the TRP group modification in a single layer 1 message or a single layer 2 message based at least in part on conditionally excluding one or more fields within the single layer 1 message or the single layer 2 message that are associated with the primary TRP group modification.

15. An apparatus for wireless communication at a user equipment (UE), comprising:
one or more memories; and
one or more processors, coupled to the one or more memories, configured to cause the UE to:
receive, in at least one of layer 1 signaling or layer 2 signaling, an indication of a transmit-receive point (TRP) group modification that is associated with a cell group of a configured cell set that includes multiple TRP groups; and
communicate in a wireless network based at least in part on the TRP group modification.

16. The apparatus of claim 15, wherein the layer 1 signaling or the layer 2 signaling comprises at least one of:
a TRP group activation medium access control (MAC) control element (CE),
a primary TRP group configuration MAC CE,
a joint TRP group activation and primary TRP group configuration MAC CE, or
downlink control information (DCI).

17. The apparatus of claim 15, wherein the TRP group modification comprises a respective activation state for each TRP group of the multiple TRP groups.

18. The apparatus of claim 15, wherein the TRP group modification comprises a change to a primary TRP group of the activated cell group from a first TRP group of the multiple TRP groups as the primary TRP group to a second TRP group of the multiple TRP groups as the primary TRP group.

19. The apparatus of claim 18, wherein the layer 1 signaling or the layer 2 signaling indicates at least one of:
a primary TRP group identifier,
a special cell (SpCell) TRP group identifier,
an SpCell configuration,
a transmission configuration indicator (TCI) state associated with an activated SpCell,
a reference signal associated with a beam management procedure,
a layer 1 measurement configuration for a deactivated TRP group of the one or more TRP groups, or
a layer 1 reporting configuration for reporting a layer 1 measurement associated with the layer 1 measurement configuration.

20. The apparatus of claim 15, wherein the TRP group modification comprises a change to an SpCell TRP group within a primary TRP group of the activated cell group from a first TRP group of the multiple TRP groups to a second TRP group of the multiple TRP groups.

21. The apparatus of claim 15, wherein the TRP group modification comprises a TRP group activation state modification and a primary TRP group modification, and
wherein the layer 1 signaling or layer 2 signaling indicates the TRP group modification in a single layer 1 message or a single layer 2 message.

22. The apparatus of claim 15, wherein the TRP group modification comprises a TRP group activation state modification and excludes a primary TRP group modification, and
wherein the layer 1 signaling or layer 2 signaling indicates the TRP group modification in a single layer 1 message or a single layer 2 message based at least in part on conditionally excluding one or more fields within the single layer 1 message or the single layer 2 message that are associated with the primary TRP group modification.

23. A method of wireless communication performed by an apparatus of a network node comprising:
selecting, for a configured cell set that includes multiple transmit-receive point (TRP) groups, a TRP group modification associated with a cell group of the configured cell set; and
transmitting the TRP group modification in at least one of layer 1 signaling or layer 2 signaling.

24. The method of claim 23, wherein selecting the TRP group modification comprises:
selecting to change a primary TRP group of the activated cell group from a first TRP group of the multiple TRP groups to a second TRP group of the multiple TRP groups.

25. The method of claim 23, wherein selecting the TRP group modification comprises:
selecting to modify an SpCell TRP group within a primary TRP group of the activated cell group from a first TRP group of the multiple TRP groups to a second TRP group of the multiple TRP groups.

26. The method of claim 23, wherein the TRP group modification comprises a TRP group activation state modification and a primary TRP group modification, and
wherein the layer 1 signaling or layer 2 signaling indicates the TRP group modification in a single layer 1 message or a single layer 2 message.

27. A method of wireless communication performed by an apparatus of a user equipment (UE) comprising:
receiving, in at least one of layer 1 signaling or layer 2 signaling, an indication of a transmit-receive point (TRP) group modification that is associated with a cell group of a configured cell set that includes multiple TRP groups; and
communicating in a wireless network based at least in part on the TRP group modification.

28. The method of claim 27, wherein the TRP group modification comprises a respective activation state for each TRP group of the multiple TRP groups.

29. The method of claim 28, wherein the TRP group modification comprises a change to a primary TRP group of the activated cell group from a first TRP group of the multiple TRP groups as the primary TRP group to a second TRP group of the multiple TRP groups as the primary TRP group.

30. The method of claim 27, wherein the TRP group modification comprises at least one of:
a change to an SpCell TRP group within a primary TRP group of the activated cell group from a first TRP group of the multiple TRP groups to a second TRP group of the multiple TRP groups, or
a TRP group activation state modification and a primary TRP group modification, wherein the layer 1 signaling or layer 2 signaling indicates the TRP group modification in a single layer 1 message or a single layer 2 message.
